(19) United States
(12) Patent Application Publication
(10) Pub. No.: US 2004/0145661 A1
(43) Pub. Date: Jul. 29, 2004

(54) Image processing method, and image processing apparatus

(75) Inventors: Tomochika Murakami, Kanagawa (JP); Satoru Wakao, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/758,023

(22) Filed: Jan. 16, 2004

(30) Foreign Application Priority Data
Jan. 21, 2003 (JP) 2003-012514
Apr. 9, 2003 (JP) 2003-105498

(51) Int. Cl. H04N 5/228

(52) U.S. Cl. 348/222.1

(57) ABSTRACT

A feature extraction unit (102) generates a feature image of an original image using an image of a first region in the original image which is formed of the first region and a second region. An encryption unit (103) generates watermark information which contains the feature image and information associated with the original image. An error-correction encoding unit 104 makes error-correction encoding of the watermark information to generate error-correction encoded watermark information. A substitution unit (106) outputs, as an output image, an image formed by replacing image information of the second region in the original image by the error-correction encoded watermark information.

### FIELD OF THE INVENTION

The present invention relates to a technique for detecting the tampered position or the presence/absence of tampering from an image.

### BACKGROUND OF THE INVENTION

In recent years, video input devices such as a digital camera that digitizes photographed information, and records digital data on a recording medium or the like have been put into practical use in place of conventional silver halide photos and 8-mm films. With such apparatus, photographed information itself can be transferred to an information processing apparatus such as a personal computer or the like, and can be displayed on that apparatus. Also, such video data can be instantaneously transmitted to the whole global locations using a communication line.

For this reason, insurance companies that use evidence photos in accident processes or construction companies that record progresses of construction sites have examined use of digital video data. However, along with the striking progress of digital process technologies, digital data such as video data and the like can be easily edited using a photo retouch tool, movie edit tool, and the like. Hence, the reliability of digital video data is lower than conventional silver halide photos and the like, and is weak as an evidence.

To solve such problem, many techniques for guaranteeing the originality of digital data and for detecting the tampered position have been developed.

As the tampering detection technique, roughly two approaches are generally available. One approach is a digital signature technique that appends, to a predetermined position (header or the like) of a file, a digital signature generated by encrypting (generating a signature) a digest (Hash value), which is calculated from a data field of digital data using a Hash function, by a private key.

The other approach is a digital watermarking technique which embeds a digital watermark that meets a given regularity in digital data itself, and detects the presence/absence of tampering of digital data or the tempered position by verifying if the given regularity is met.

In the former digital signature technique, since the digital signature for image verification is appended to the predetermined position (header or the like) of a file, if the header information is removed by file format conversion, tampering can no longer be detected from the format-converted file.

On the other hand, the latter digital watermarking technique has robustness against file format conversion since it embeds a digital watermark that meets the given regularity in digital data itself, but causes image deterioration.

A conventional digital watermark used to detect a tampered position will be explained below. In a conventional digital watermark embedding apparatus for tampered position detection, input image data is segmented into two regions for each pixel (e.g., in case of an 8-bit grayscale image, the upper 7 bits and least significant bit), and data (e.g., the upper 7 bits) of one image region of a pixel position corresponding to a random number, which is generated from predetermined key information depending on the pixel position, is input to an encryption function for each pixel which is to undergo an embedding process, thus generating watermark information (1 bit) for each pixel. The generated watermark information (1 bit) replaces data of the other segmented image region (e.g., the least significant bit). Such operation is repeated for all the pixels of an input image, thus embedding a digital watermark used to detect a tampered position.

In a tampered position detection apparatus, input image data is segmented into two image regions for each pixel as in embedding, and data (e.g., the upper 7 bits) of one image region of a pixel position corresponding to a random number, which is generated from predetermined key information depending on the pixel position, is input to an encryption function for each pixel which is to undergo a verification process, thus generating watermark information (1 bit) for each pixel. The generated watermark information (1 bit) for each pixel is compared with data (e.g., the least significant bit) of the other corresponding segmented image region. If the two bit values are different from each other, it is determined that the pixel position of interest has been tampered with; otherwise, it is determined that the pixel position of interest is not tampered with. This operation is repeated for all pixels of an input image, thus detecting a tampered position in the image.

Since watermark data is generated as binary data of 1 or 0 on the basis of a random number generated from the key information in correspondence with the pixel position and data of one image region using the encryption function, tampering can be detected only when 1 or 0 is inverted. Although this scheme allows its algorithm to be open to the public as its merit, if a random number generated from the predetermined key information leaks, a tampered image which is determined not to be tampered with can be easily generated. Hence, this random number must be set as secret information.

In another conventional digital watermark embedding apparatus for tampered position detection, image data is segmented into two regions, and a pseudo halftone image is generated from one image region. The pseudo halftone image undergoes a randomization process for re-arranging to random positions using private key information, thus generating watermark image data in which embedded positions are distributed over the entire image. Finally, the watermark image is replaced by other image region, and an image embedded with the watermark used to detect a tampered position is output.

In a tampered position detection apparatus, a tampered image with a watermark is segmented into two regions to acquire image data of one region. The embedded positions of the image data of one region are inversely randomized to reclaim a pseudo halftone image. Image data of the other region is acquired from the tampered image with the watermark, and a pseudo halftone image is generated again.

Finally, the pseudo halftone image reclaimed from one region of the tampered image is compared with that generated from the image data of the other region, thus specifying a tampered position.

This scheme allows its algorithm to be open to the public and an original image state can be recognized from the reclaimed pseudo halftone image as its merits. However, since damaged portions upon tampering are distributed over the entire image as a result of derandomization, an accurate tampered position cannot be specified.

The latter conventional scheme allows to recognize the original image state as its merit, but cannot specify an accurate tampered position.

When the aforementioned conventional digital watermark technique is used, the tampered position can be specified. However, since key information required to embed a digital watermark used to detect a tampered position is the same as that required to detect a tampered position, the key information required to detect a tampered position cannot be open to the public since it allows tampering if it leaks to a third party. Hence, only limited persons or devices can verify images, resulting in inconvenience.

### SUMMARY OF THE INVENTION

The present invention has been made in consideration of the above problems, and has as its object to accurately detect a tampered position on an image.

In order to achieve the object of the present invention, for example, an image processing apparatus according to the present invention has the following arrangement.

That is, there is provided an image processing apparatus for generating information that allows to detect a position of tampering for an original image which is formed of first and second regions, comprising:

feature image generation means for generating a feature image of the original image using an image of the first region;

watermark information generation means for generating watermark information which contains the feature image and information associated with the original image;

error-correction encoding means for generating error-correction encoded watermark information by making error-correction encoding of the watermark information; and

output means for outputting, as an output image, an image formed by replacing image information of the second region in the original image by the error-correction encoded watermark information.

In order to achieve the object of the present invention, for example, an image processing apparatus according to the present invention has the following arrangement.

That is, there is provided an image processing apparatus for detecting a position of tampering in a tampered image which is formed of first and second regions, comprising:

error-correction decoding means for making error-correction decoding of an image based on the second region to reclaim watermark information which contains a feature image that represents a feature of the tampered image before tampering, and information associated with an image before tampering of the tampered image;

feature image generation means for generating a feature image of the tampered image using an image of the first region; and

tampered position notifying means for notifying the position of tampering in the tampered image using the feature image which is contained in the watermark information and represents the feature of the tampered image before tampering, and the feature image of the tampered image.

In order to achieve the object of the present invention, for example, an image processing apparatus according to the present invention has the following arrangement.

That is, there is provided an image processing apparatus for generating information that allows to detect a position of tampering for an original image which is formed of first and second regions, comprising:

encryption means for encrypting watermark information, which is generated in advance, to generate encrypted watermark information;

error-correction encoding means for making error-correction encoding of the encrypted watermark information to generate error-correction encoded, encrypted watermark information; and

output means for outputting, as an output image, an image formed by replacing image information of the second region in the original image by the error-correction encoded, encrypted watermark information.

In order to achieve the object of the present invention, for example, an image processing apparatus according to the present invention has the following arrangement.

That is, there is provided an image processing apparatus for detecting a position of tampering in a tampered image which is formed of first and second regions, comprising:

error-correction decoding means for making error-correction decoding of an image based on the second region to generate an error-corrected image based on the second image, so as to reclaim encrypted watermark information;

decryption means for decrypting the encrypted watermark information to reclaim watermark information; watermark information verification means for verifying consistency of the watermark information; and

tampered position detection means for, when the watermark information meets the consistency, detecting a tampered position by comparing the image based on the second region and the error-corrected image based on the second region.

In order to achieve the object of the present invention, for example, an image processing method according to the present invention has the following arrangement.

That is, there is provided an image processing method for generating information that allows to detect a position of tampering for an original image which is formed of first and second regions, comprising:

a feature image generation step of generating a feature image of the original image using an image of the first region;

a watermark information generation step of generating watermark information which contains the feature image and information associated with the original image;

an error-correction encoding step of generating error-correction encoded watermark information by making error-correction encoding of the watermark information; and

an output step of outputting, as an output image, an image formed by replacing image information of the second region in the original image by the error-correction encoded watermark information.

In order to achieve the object of the present invention, for example, an image processing method according to the present invention has the following arrangement.

That is, there is provided an image processing method for detecting a position of tampering in a tampered image which is formed of first and second regions, comprising:

an error-correction decoding step of making error-correction decoding of an image based on the second region to reclaim watermark information which contains a feature image that represents a feature of the tampered image before tampering, and information associated with an image before tampering of the tampered image;

a feature image generation step of generating a feature image of the tampered image using an image of the first region; and

a tampered position notifying step of notifying the position of tampering in the tampered image using the feature image which is contained in the watermark information and represents the feature of the tampered image before tampering, and the feature image of the tampered image.

In order to achieve the object of the present invention, for example, an image processing method according to the present invention has the following arrangement.

That is, there is provided an image processing method for generating information that allows to detect a position of tampering for an original image which is formed of first and second regions, comprising:

an encryption step of encrypting watermark information, which is generated in advance, to generate encrypted watermark information;

an error-correction encoding step of making error-correction encoding of the encrypted watermark information to generate error-correction encoded, encrypted watermark information; and

an output step of outputting, as an output image, an image formed by replacing image information of the second region in the original image by the error-correction encoded, encrypted watermark information.

In order to achieve the object of the present invention, for example, an image processing method according to the present invention has the following arrangement.

That is, there is provided an image processing method for detecting a position of tampering in a tampered image which is formed of first and second regions, comprising:

an error-correction decoding step of making error-correction decoding of an image based on the second region to generate an error-corrected image based on the second image, so as to reclaim encrypted watermark information;

a decryption step of decrypting the encrypted watermark information to reclaim watermark information;

a watermark information verification step of verifying consistency of the watermark information; and

a tampered position detection step of detecting, when the watermark information meets the consistency, a tampered position by comparing the image based on the second region and the error-corrected image based on the second region.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the functional arrangement of a digital watermark embedding apparatus for tampered position detection according to the first embodiment of the present invention;

FIG. 2 shows an input image, which is expressed by 8 bits per pixel, for respective bit planes;

FIG. 3 shows an input image, a two-dimensional feature image, and an image expressed by randomized error-correction encoded, encrypted watermark information (to be described later);

FIG. 4 is a block diagram showing the functional arrangement of a tampered position detection apparatus;

FIG. 5 is a view for explaining a process for determining a tampered position from a tampered image;

FIG. 6 is a schematic view for explaining, by comparison, the bit lengths of watermark information (601), encrypted watermark information (602), error-corrected encoded watermark information (603), and randomized error-corrected encoded watermark information (604);

FIG. 7 shows an example of watermark information C(w) before error-correction encoding;

FIG. 8 shows the schematic configuration of “watermark information”

FIG. 9 is a block diagram showing the functional arrangement of a digital watermark embedding apparatus for tampered position detection according to the second embodiment of the present invention;

FIG. 10 is a block diagram showing the functional arrangement of a tampered position detection apparatus according to the second embodiment of the present invention;

FIG. 11 is a flow chart showing the flow of a tampered position detection process according to the second embodiment of the present invention;

FIG. 12 shows a two-dimensional matrix of DCT quantization coefficients which are obtained by computing the discrete cosine transforms of a partial region (8×8 pixels) of an image and quantizing the transformation coefficients using a predetermined quantization table;

FIG. 13 shows the layout of DWT coefficients obtained by computing the discrete wavelet transforms of a tile of interest;

FIG. 14 is a block diagram showing the basic arrangement of a computer which serves as the embedding apparatus and tampered position detection apparatus according to the first to eighth embodiments of the present invention;

FIG. 15 is a block diagram showing the functional arrangement of a digital watermark embedding apparatus for tampered position detection in article (1);

FIG. 16 is a block diagram showing the functional arrangement of a tampered position detection apparatus in article (1);

FIG. 17 is a block diagram showing the functional arrangement of a tampered position detection apparatus according to the third embodiment of the present invention;

FIG. 18 is a block diagram showing the functional arrangement of a second tampered position detection unit 1700;

FIG. 19 is a flow chart showing the flow of a tampered position detection process according to the third embodiment of the present invention;

FIG. 20 is a flow chart showing details of step A1 (step S1910) in FIG. 19;

FIG. 21 is a flow chart showing details of step A2 (step S1920) in FIG. 19;

FIG. 22 is a view for explaining a process for determining a tampered position from a tampered image; and

FIG. 23 shows the correspondence between a second tampered position specifying bit sequence S(BS) and a tampered image.

### DETAILED DESCRIPTION OF THE PREFERRED EMBODIMENTS

Preferred embodiments of the present invention will now be described in detail in accordance with the accompanying drawings.

Note that a description of prior art will be given first to clarify the differences between the method of the present invention and the prior art.

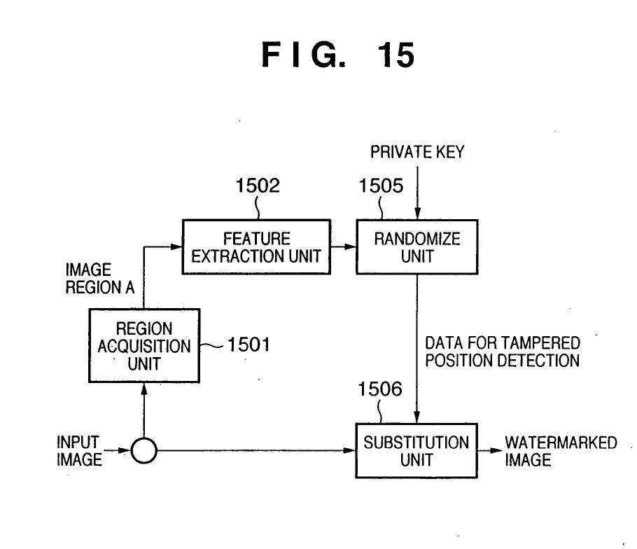

FIG. 15 is a block diagram showing the functional arrangement of a digital watermark embedding apparatus for tampered position detection in article “Watermarking Method For Detecting Alteration of Digital Images Which Indicates State before Alteration” published in Computer Security Symposium 2002. Note that article “Watermarking Method For Detecting Alteration of Digital Images Which Indicates State before Alteration” will be referred to as article (1) hereinafter.

A grayscale image in which the pixel value of each pixel is expressed by 8 bits is input to a region acquisition unit 1501, which outputs bit planes of the upper 7 bits except for the LSB as image region A to a feature extraction unit 1502. The feature extraction unit 1502 extracts a binary image (two-dimensional (2D) feature image) from image region A by a method using simulated annealing, and outputs that binary image to a randomize unit 1505.

As one of typical pseudo halftone image generation methods, error diffusion is known. Since error diffusion calculates pseudo halftone values while diffusing an error between the pseudo halftone value and the pixel value of an original image in turn, the pseudo halftone calculation of a tampered portion influences that of other portions. Therefore, since a tampered portion cannot be specified, error diffusion is not suited as the process in the feature extraction unit. Simulated annealing used in the above article is a method of calculating a binary image that minimizes (strictly speaking, locally minimizes) the energy by a simulated annealing algorithm to have a visual difference between the original image and binary image as an energy function. The pseudo halftone calculation of a tampered portion does not influence that of other portions.

The randomize unit 1505 randomizes the input binary image (2D feature image), and outputs the randomized binary image (2D feature image) to a substitution unit 1506.

Finally, the substitution unit 1506 substitutes the LSB bit plane of the input image by the randomized binary image input from the randomize unit, thus generating a watermarked image.

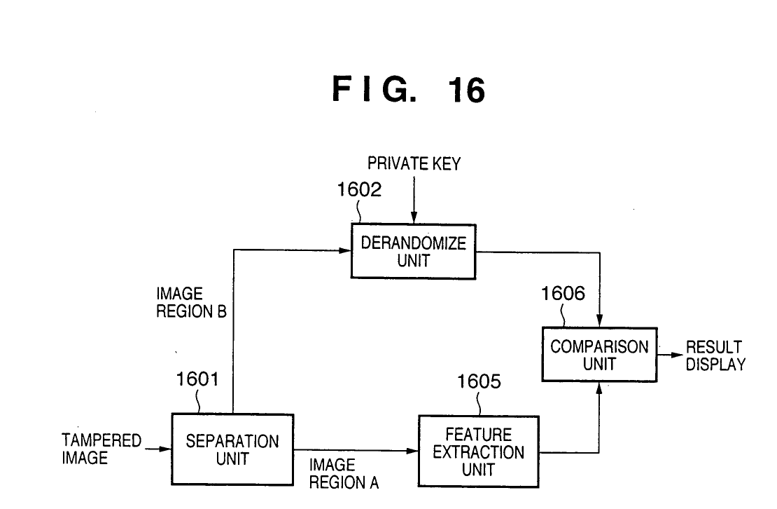

FIG. 16 is a block diagram showing the functional arrangement of a tampered position detection apparatus in article (1).

A tampered image is input to a separation unit 1601. The separation unit 1601 separates the input image into image region A (bit planes of the upper 7 bits except for the LSB) and image region B (bit plane of the LSB), and outputs these image regions to a feature extraction unit 1605 and derandomize unit 1602, respectively.

The derandomize unit 1602 applies a randomization process opposite to the randomize unit 1505 in the digital watermark embedding apparatus for tampered position detection to image region B input from the separation unit 1601, i.e., a binary image (bit plane of the LSB), and a locally damaged binary image which represents a feature of an original image to a comparison unit 1606. At this time, in article (1), information required for reordering in the derandomize unit 1602 must be held as private key information so as to prevent a tampered image from which tampering cannot be detected from being generated.

The feature extraction unit 1605 applies the same process as that of the feature extraction unit 1502 in the digital watermark embedding apparatus for tampered position detection to input image region A (bit planes of the upper 7 bits except for the LSB) so as to generate a binary image that extracts a feature of the tampered image, and outputs the binary image to the comparison unit 1606.

The comparison unit 1606 compares the locally damaged binary image which is input from the derandomize unit 1602 and represents a feature of the original image, and the binary image which is input from the feature extraction unit 1605 and extracts a feature of the tampered image, thus specifying a tampered position. However, article (1) often specifies a wrong tampered position as follows, as has been briefly described above.

In the tampered position detection apparatus of article (1), image region B of the tampered image input to the derandomize unit 1602 is more likely to be locally damaged by tampering. Since locally damaged image region B undergoes the randomization process to diffuse the damaged portion to the entire image, a binary image in which errors are entirely diffused can be obtained. However, when the comparison unit 1606 compares that binary image with the binary image (2D feature image) calculated from image region A, an accurate tampered position cannot be specified, since errors are diffused to the entire image. As a result, an image position which is not tampered with in practice may be detected as a tampered position.

Embodiments in which an image processing apparatus according to the present invention is applied to a digital watermark embedding apparatus for tampered position detection and a tampered position detection apparatus will be described hereinafter.

[First Embodiment]

<Digital Watermark Embedding Apparatus for Tampered Position Detection>

A digital watermark embedding apparatus which embeds a digital watermark that allows tampered position detection by a public key, i.e., a key that everybody can access will be described below.

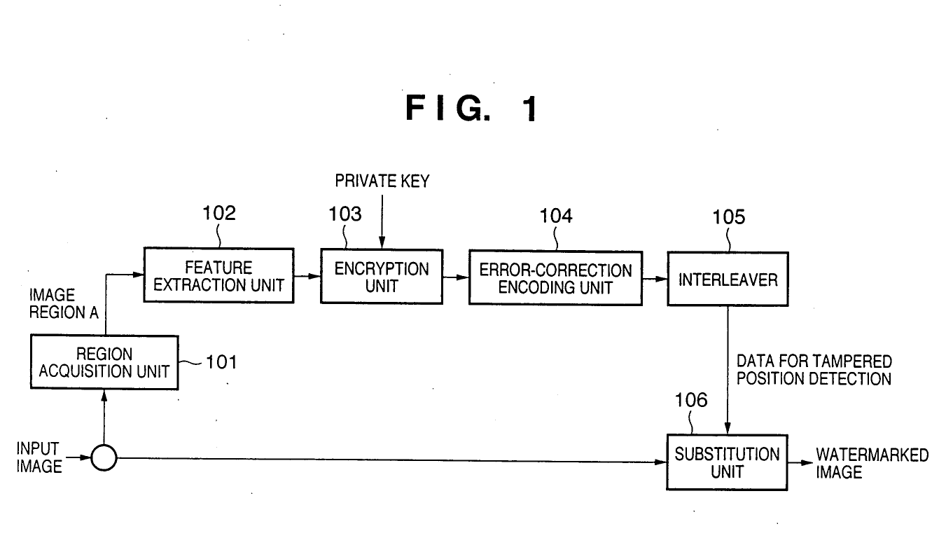

FIG. 1 is a block diagram showing the functional arrangement of a digital watermark embedding apparatus for tampered position detection. Respective units shown in FIG. 1 may be implemented by hardware or may be implemented by describing the functions of the respective units as programs, and loading the programs onto a computer.

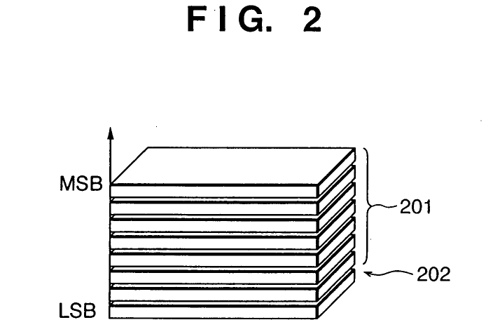

FIG. 2 shows an input image, which is expressed by 8 bits per pixel, for respective bit planes. For the sake of easy understanding, assume that an input image is a grayscale image which is expressed by 8 bits per pixel, as shown in FIG. 2, in this embodiment.

The process to be executed by the digital watermark embedding apparatus for tampered position detection will be described below with reference to FIG. 1.

An input image (which will also be referred to as an original image hereinafter, and consists of 512 pixels (height)×512 pixels (width)) is input to a region acquisition unit 101. The region acquisition unit 101 acquires predetermined image region A from the input image, and outputs that image region to a feature extraction unit 102. For the sake of simplicity, the region acquisition unit 101 acquires bit planes of the upper 7 bits (bit plane group 201 shown in FIG. 2) except for a bit plane of the least significant bit (LSB) (bit plane 202 shown in FIG. 2) of the input image as image region A.

The feature extraction unit 102 outputs a 2D-feature image that expresses a feature of the input image using an image of input image region A, i.e., an image expressed by the bit planes of the upper 7 bits of the input image.

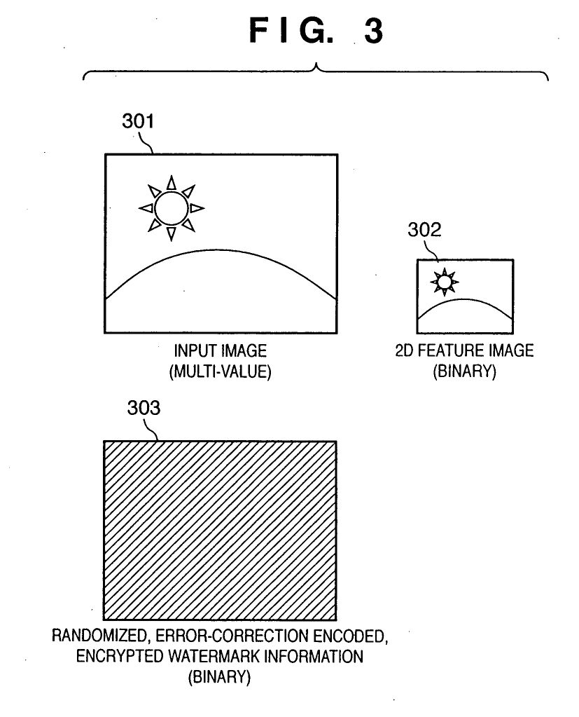

FIG. 3 shows an input image, 2D feature image, and image expressed by randomized error-correction encoded, encrypted watermark information.

As shown in FIG. 3, a 2D feature image 302 output from the feature extraction unit 102 is a 1-bit image with the smaller height and width than an input image 301. As will be described in detail later, this is to allow the 2D feature image to fall within image region B (the LSB of the input image in this embodiment) even after encryption and error-correction encoding of the 2D feature image.

For example, the feature extraction unit 102 executes the following processes. That is, an image in which the pixel value of each pixel is expressed by 8 bits is generated by adding the LSB bit plane of all zeros to image region A, the height and width of this image are reduced to ½, and respective pixel values of the reduced image are compared with the values of a predetermined matrix (e.g., a Bayer matrix) to binarize that image (ordered dithering). Also, blue noise masking which can obtain a high-quality binary image although it is based on dithering is available. In addition, a contour extraction process may be used. Furthermore, simulated annealing described in article (1) may be used in the feature extraction unit 102.

When an input image is a document image, layout analysis and an OCR process may be applied to the input image to store text information and layout information extracted by the OCR process in a document format that can store test information and a 2D layout, thus generating a 2D feature image. As described above, various types of processes to be executed by the feature extraction unit 102 can be designed.

The feature extraction unit 102 preferably executes a process that can extract a feature of the entire input image, and can generate a 2D feature image, which is substantially the same as an original image except for a locally changed portion, on the basis of the input image, which has the locally changed portion.

FIG. 3 depicts the input image 301 and 2D feature image 302. In this embodiment, the height and width of the input image are reduced to ½ and the reduced image undergoes a binarization process so as to generate a 2D feature image. However, such reduction and binarization processes are not indispensable, and a 2D feature image with a size equal to that of the input image or a multi-valued grayscale 2D feature image may be generated as long as image region B has a size large enough to store such 2D feature image.

The 2D feature image is input to an encryption unit 103. The encryption unit 103 combines the input 2D feature image and various data as needed to generate watermark information for tampered position detection. The watermark information for tampered position detection will be referred to as “watermark information” or w hereinafter.

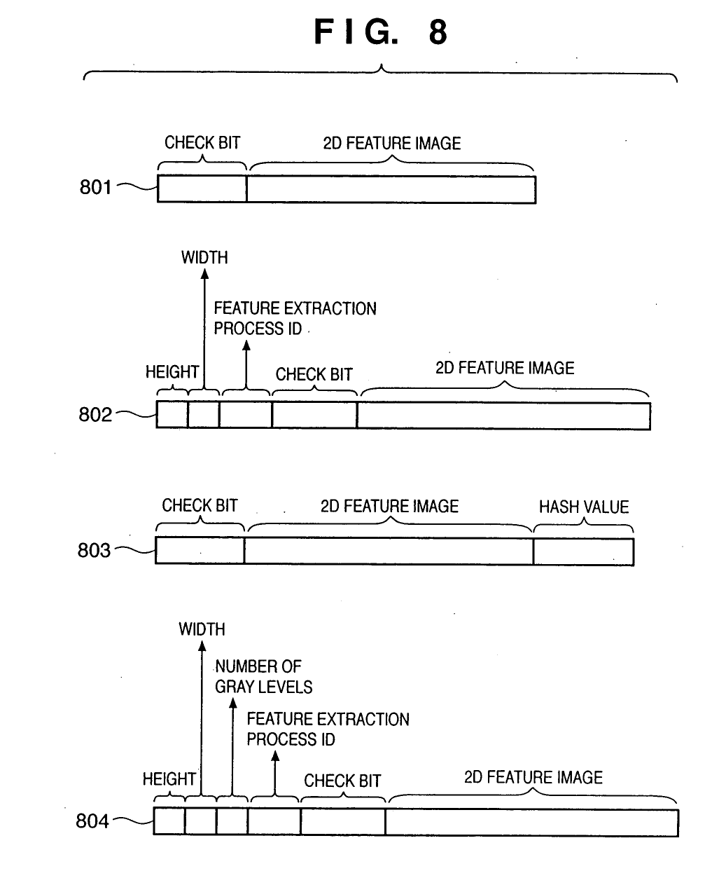

FIG. 8 shows a schematic configuration of the “watermark information”. FIG. 8 shows a plurality of configuration examples 801 to 804 of “watermark information”, but the internal configuration of the “watermark information” is not limited to such specific configuration examples 801 to 804.

As various data to be combined with the 2D feature image, “check bits” used for the purpose of checking if decryption is normally done (801 in FIG. 8), “height” and “width” indicating the height and width of the 2D feature image as binary values, and “feature extraction process ID” as one of information that specifies a feature extraction process used upon generating a 2D feature image (802 in FIG. 8), and the like may be used. Furthermore, “bit length of 2D feature image”, “photographing date”, “position information” obtained from a GPS, “serial number of photographing device”, “photographer information”, and the like may be added (none of them are shown).

The check bits are bit information used to verify consistency of some components (the 2D feature image and information such as “height”, “width”, “feature extraction process ID”, and the like) of the watermark information that contains at least the 2D feature image. For example, a Hash value obtained by inputting some components of the watermark information that contains at least the 2D feature image to a Hash function may be used. The Hash value returns, as its nature, a largely different fixed-length value with respect to even a slight change in input value. Therefore, if check bits that exploit the Hash value are used, matching can be verified with high precision with respect to such slight change. Also, a check sum used to check if the 2D feature image has an error may be used as the check bits.

The encryption unit 103 applies an encryption process to the generated watermark information. The encryption unit 103 can adopt various cryptosystems. As a merit upon adopting a public key cryptosystem, even persons or devices which do not have any private key can detect the tampered position using a corresponding public key. For this reason, this embodiment executes an encryption process according to the public key cryptosystem. However, the encryption unit 103 may use a common key cryptosystem. At this time, only persons or devices which have a common key can detect the tampered position, but a processing speed higher than the public key cryptosystem can be assured when the common key cryptosystem is used.

Since the public key cryptosystem is a state-of-the-art technique, a detailed description thereof will be omitted. With the public key cryptosystem, data encrypted using a private key can be easily decrypted by a public key, but it is practically impossible to generate normally consistent data that can be decrypted by the public key unless the private key is known.

Hence, it is practically impossible to generate encrypted watermark information that contains a 2D feature image corresponding to tampered image data, which can be decrypted by the public key corresponding to the private key, as long as the private key is strictly managed inside an image sensing device such as a digital camera, video camera, or the like so as not to be read out. Note that the RSA cryptosystem, elliptic curve cryptosystem, and the like are well known as the public key cryptosystem.

The encryption unit 103 encrypts (generates a signature) the watermark information by a private key using the public key cryptosystem, thus outputting encrypted watermark information. In the following description, C(w) represents the encrypted watermark information.

The information size of the encrypted watermark information C(w) will be examined below. The data size of the encrypted watermark information C(w) output from the encryption unit 103 may change from that of the watermark information w as input data. For example, when the encryption unit adopts the RSA cipher, since the watermark information w is processed based on a key length, C(w) has a length proportional to the key length.

Assume that the key length of the RSA cipher used in the encryption unit 103 is 1024 bits, the 2D feature image input to the encryption unit 103 is expressed by 1 bit per pixel and has a size of 256 pixels (height)×256 pixels (width) (65536 bits), and check bits are a 160-bit Hash value calculated from the 2D feature image. Then, watermark information input to the encryption unit 103 is 65696 bits. As described above, since the RSA cipher processes input data based on the key length, predetermined bit values (e.g., zeros) are appended (padded) to the last bit information less than 1024 bits, and the bit information is processed based on 1024 bits. Hence, the bit length of the encrypted watermark information C(w) output from the encryption unit 103 is an integer multiple of the key length, i.e., 66560 bits.

In this way, when predetermined bits (e.g., zeros) are appended to the end of the watermark information in the encryption process, predetermined bits (e.g., zeros) are also appended to the end of even the watermark information upon decryption. When the size of the 2D feature image is not known in advance, the length of the 2D feature image data is calculated using “height” and “width” (when the watermark information has the configuration 802 or 804 in FIG. 8) as information contained in the watermark information, thus accurately extracting the 2D feature image contained in the watermark information.

The watermark information undergoes a padding process to have a length corresponding to an integer multiple of the key length, and then undergoes an encryption process. In this case, predetermined fixed bits may be padded as padding bits to also serve as “check bits”.

The encrypted watermark information C(w) is input to an error-correction encoding unit 104. The error-correction encoding unit 104 applies an error-correction encoding process to the encrypted watermark information C(w) and outputs error-correction encoded, encrypted watermark information. In the following description, ECC(C(w)) represents error-correction encoded, encrypted watermark information.

As an error-correction code used in the error-correction encoding unit 104, various codes such as BCH code, Reed-Solomon code, convolution code, turbo code, and the like are available, and an appropriate error-correction code is preferably selected in correspondence with the types of expected tampering, i.e., errors that may occur.

As the types of errors, a “random error” which independently occurs for respective bits, a “burst error” which continuously occurs to be concentrated locally, a “byte error” which occurs for respective small blocks (called bytes) each consisting of predetermined bits, and the like are known. In general, the “BCH code” is effective for a “random error”, and the “Reed-Solomon code” is effective for a “byte error”. After information is encoded by the “Reed-Solomon code”, the encoded information undergoes an interleave process (e.g., a randomization process) to become robust against a “burst error”. Note that the interleave process is not limited to the randomization process, and various schemes and designs for stirring the arrangement of an information sequence are available. In this embodiment, the randomization process will be exemplified as the interleave process, but the interleave process is assumed as a process for stirring the arrangement of an information sequence and is not limited to the randomization process.

As for tampering of an image, tampering concentrated on a specific portion of an image is normally assumed. Therefore, when error-correction encoding using a code which is robust against a “burst error” is applied to an image, tampering concentrated on the specific portion can be detected as a “burst error”.

However, when the encrypted watermark information C(w) undergoes a randomization process by an interleaver after encoding without using any code robust against a “burst error”, that information can become robust against the “burst error”. At this time, the decoding side of the error-correction code must restore the order of an encoded bit sequence by applying a derandomization process to the error-correction encoded, encrypted watermark information ECC(C(w)) by a deinterleaver before an error-correction decoding process, and must then decode the information.

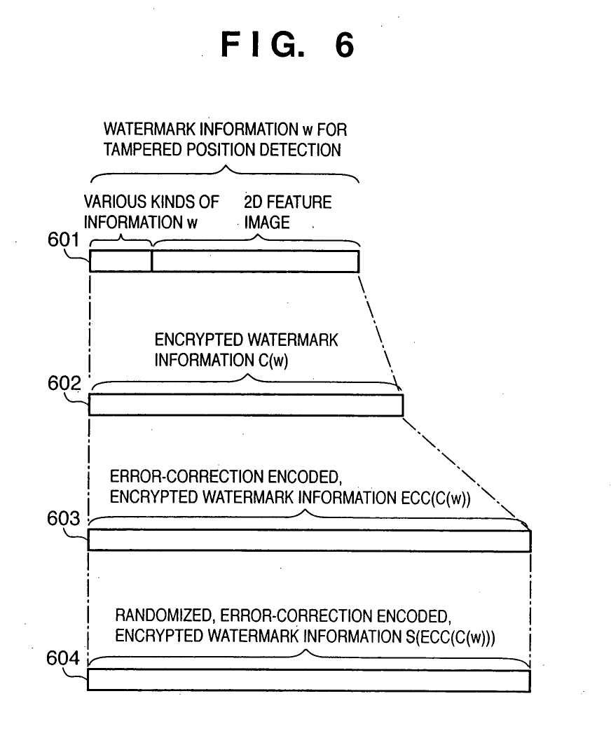

FIG. 6 is a schematic view for explaining, by comparison, the bit lengths of watermark information (601), encrypted watermark information (602), error-correction encoded watermark information (603), and randomized error-correction encoded watermark information (604).

The information size (reflected in the bit length in FIG. 6) of error-correction encoded watermark information 603 becomes larger than that of encrypted watermark information 602 since redundant bits are added for the purpose of error correction.

Error-correction encoding parameters in the error-correction encoding unit 103 are preferably designed so that the information size of the encrypted watermark information ECC(C(w)) accurately falls in image region B (the LSB bit plane in the first embodiment). For example, the error-correction encoding parameters may be fixed, and the padding process may be applied to the encrypted watermark information size to obtain an information size that can accurately fall in image region B after error correction, or a check sum or the like may be added in place of the padding process to assure more accurate error-correction decoding. Also, the error-correction encoding parameters in the error-correction encoding unit 103 may be set to obtain an information size that can accurately fall in image region B after error-correction encoding without any padding or check sum.

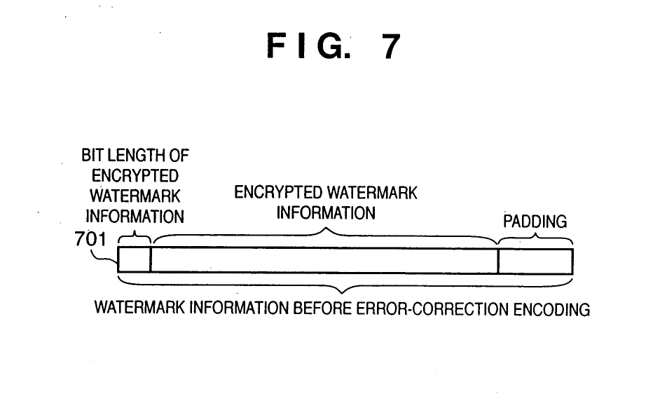

FIG. 7 shows an example of watermark information C(w) before error-correction encoding. In FIG. 7, predetermined bits (e.g., zeros) are padded to the end of information so that the information after error-correction encoding can accurately fall in image region B. At this time, when a bit sequence that describes the bit length of the encrypted watermark information is recorded as a binary value at the location of “bit length of encrypted watermark information” in the encrypted watermark information C(w) before error-correction encoding, even if padding bits are added, the bit sequence of the encrypted watermark information can be accurately extracted.

The error-correction encoding unit 104 can reinforce the error-correction performance by utilizing robustness as the size of the encrypted watermark information C(w) is smaller (i.e., as the information size of the 2D feature image is smaller).

As a result, even when an image embedded with a watermark suffers serious tampering, the tampered position can be specified. By contrast, as the information size of the 2D feature image is larger, the error-correction encoding unit 104 cannot make robust error correction.

Since the information size of the 2D feature image and the robustness of error-correction encoding (that against tampering) have a trade-off relationship, this embodiment can determine the information size of the 2D feature image and the robustness parameters of error-correction encoding in accordance with the purposes intended. As one of large advantages of this embodiment, the parameters can be flexibly set in accordance with the purposes intended in this way. The information size of the 2D feature image and the robustness parameters of error-correction encoding may be set as default parameters that can be obtained empirically, may be automatically determined in accordance with an image sensed by an image sensing device, or may be selected by the user upon embedding a digital watermark for tampered position detection.

The error-correction encoded, encrypted watermark information ECC(C(w)) is then input to an interleaver 105. The interleaver 105 randomly reorders the bit sequence that forms the input error-correction encoded, encrypted watermark information ECC(C(w)), and outputs randomized error-correction encoded, encrypted watermark information. At this time, key information used in reordering is also required upon detecting the tampered position. In this embodiment, this key information can be open to the public since it is impossible to tamper with information using this key information.

Note that the interleaver 105 is not an indispensable block, and may be omitted when the error-correction encoding unit 104 uses an error-correction code which has error correction performance against tampering (burst error) concentrated at a specific portion, or uses an error-correction code having an interleaver function.

In the following description, S(ECC(C(w))) represents the randomized error-correction encoded, encrypted watermark information.

Finally, the error-correction encoded, encrypted watermark information S(ECC(C(w))) randomized by the interleaver 105 is input to a substitution unit 106, which substitutes predetermined image region B (LSB bit plane corresponding to 202 in FIG. 2 in this embodiment) of the input image by the input information, thus outputting a watermarked image embedded with the randomized error-correction encoded, encrypted watermark information S(ECC(C(w))) as an output image.

FIG. 3 depicts an image 303 formed by arranging the randomized error-correction encoded, encrypted watermark information S(ECC(C(w))) which substitutes the LSB bit plane in the substitution unit 106 in the raster scan order. The information size of the image 303 is larger than that of the 2D feature image 302 due to the encryption process and error-correction encoding process.

For example, for the sake of easy understanding, assume that an input image is a grayscale image which has a size of 512 pixels (height)×512 pixels (width) and is expressed by 8 bits per pixel, a 2D feature image is a monochrome image which has a size of 256 pixels (height)×256 pixels (width) and is expressed by 1 bit per pixel, and the error-correction encoded, encrypted watermark information S(ECC(C(w))) is a monochrome image which has a size of 512 pixels (height)×512 pixels (width) and is expressed by 1 bit per pixel.

<Tampered Position Detection Apparatus>

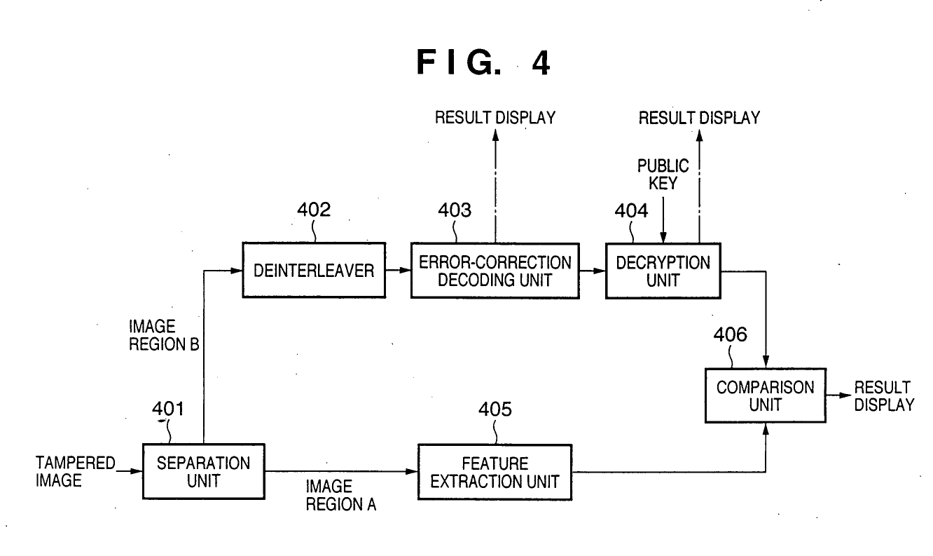

A tampered position detection apparatus will be described in detail hereinafter. FIG. 4 is a block diagram showing the functional arrangement of the tampered position detection apparatus. Respective units shown in FIG. 4 may be implemented by hardware or may be implemented by describing the functions of the respective units as programs, and loading the programs onto a computer.

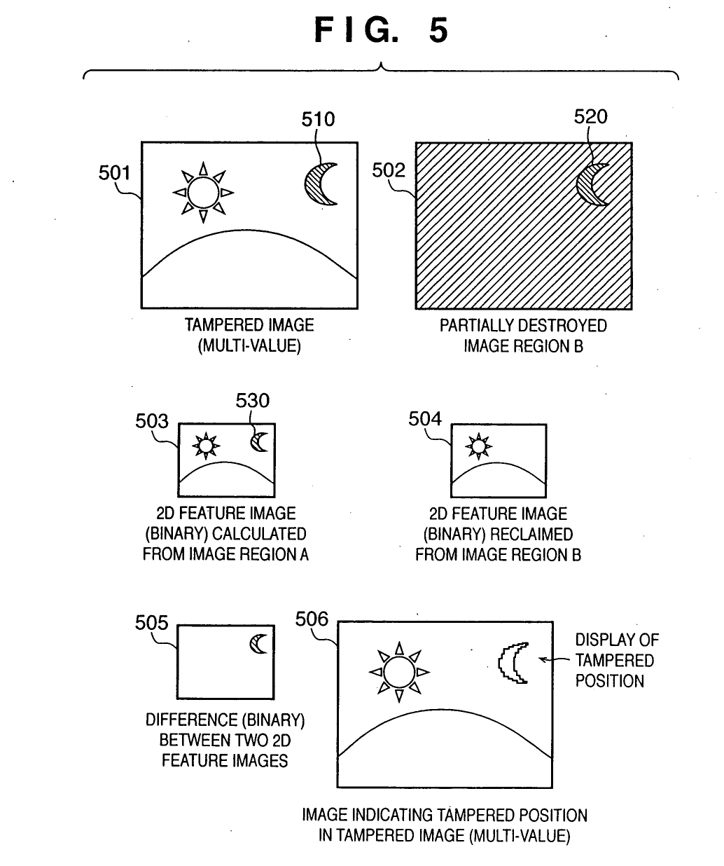

FIG. 5 is a view for explaining a process for determining a tempered position from a tampered image. The process to be executed by the tampered position detection apparatus will be described below using FIG. 5 with reference to the block diagram of FIG. 4.

Referring to FIG. 5, reference numeral 501 denotes a tampered image; and 510, a tampered region (a hatched crescent region). In the following description, the tampered image 501 will be exemplified, but the process to be described hereinafter can be applied to various other tampered images.

The tampered image 501 (input image) is input to a separation unit 401 so as to verify a tampered position. The separation unit 401 separates the input image into image region A, and image region B embedded with watermark information for tampered position detection. In this embodiment, image region A corresponds to the bit planes 201 of the upper 7 bits except for the bit plane of the least significant bit (LSB), and image region B corresponds to the LSB bit plane 202, as shown in FIG. 2, as in the embedding apparatus.

In FIG. 5, reference numeral 502 denotes image data which indicates image region B separated from the input image. The image data 502 of image region B separated from the input image may be destroyed at a tampered position (a position of a region 520).

The data of image region B separated by the separation unit 401 is input to a deinterleaver 402. The deinterleaver 402 executes a process for restoring (derandomizing) the arrangement of the bit sequence which form partially destroyed, randomized error-corrected encoded encrypted watermark information S′(ECC(C(w))).

The deinterleaver 402 outputs the derandomized, partially destroyed, error-correction encoded, encrypted watermark information (to be expressed by ECC′(C(w)) hereinafter) to an error-correction decoding unit 403. Note that some error-correction codes do not require any interleaver upon embedding. Therefore, the process in the deinterleaver 402 is not indispensable, and is required only when ECC(C(w)) is randomized by the interleaver 105 upon embedding.

ECC′(C(w)) output from the deinterleaver 402 is input to the error-correction decoding unit 403. The error-correction decoding unit 403 makes error-correction decoding of the input partially destroyed ECC′(C(w)) and outputs encrypted watermark information C(w) to a decryption unit 404.

When watermark data in image region B is seriously destroyed by tampering, and the error-correction code cannot normally undergo error-correction decoding (in this case, the error-correction code itself must have a function of informing that normal error-correction decoding is disturbed), a message “a tampered position cannot be specified, but the entire image has been tampered with” is displayed as a result, thus ending the process.

The error-correction decoded encrypted watermark information C(w) input to the decryption unit 404 is decrypted using a public key which is acquired by the public key cryptosystem and corresponds to the private key used in encryption to reclaim watermark information w.

When the public key used in tampered position detection is correct, the decryption unit 404 checks the value of check bits which form the watermark information w (when the check bits represent a Hash value of a 2D feature image, a Hash value is calculated from the 2D feature image contained in the watermark information w, and is compared with the check bits in the watermark information w to determine whether or not they match), thus identifying whether the encrypted watermark information C(w) is encrypted (undergoes signature generation) using a correct or different private key. In the public key cryptosystem, no one can generate normally consistent watermark information which can be decrypted by a public key unless he or she knows a private key.

Therefore, if the check bit values do not match, it means that the encrypted watermark information C(w) is not encrypted using a correct private key. Hence, in such case, the apparatus notifies the user of a message “the image has been illicitly tampered with”, thus ending the process. Since misuse of a public key used in tampered position detection also leads to a check bit value error, the apparatus may notify the user of a message “a wrong key is used in decryption”.

The decryption unit 404 extracts a 2D feature image from the decrypted watermark information w, which corresponds to 601 in FIG. 6, and outputs the extracted 2D feature image to a comparison unit 406. In FIG. 5, reference numeral 504 denotes a 2D feature image restored from image region B of the tampered image 502. As denoted by 504 in FIG. 5, the 2D feature image extracted from the watermark information w is a similar image to the original image.

When the watermark information decrypted by the decryption unit 404 contains “feature extraction process ID”, the type of feature extraction process to be executed by a feature extraction unit 405 may be determined based on the feature extraction process ID.

The feature extraction unit 405 executes a feature extraction process of image region A input from the separation unit 401. At this time, the feature extraction process is the same process as the generation method of the 2D feature image generated upon embedding a watermark. The feature extraction unit 405 outputs a 2D feature image extracted by the feature extraction process to the comparison unit 406.

In FIG. 5, reference numeral 503 denotes a 2D image extracted from the tampered image by the feature extraction process. At this time, as denoted by 503 in FIG. 5, a 2D feature image calculated from the tampered image may reflect tampering (in the example shown in FIG. 5, the tampered region 510 in the input image 501 is reflected as a tampered region 530).

Finally, the comparison unit 406 compares the normally reclaimed 2D feature image input from the decryption unit 404, and the 2D feature image which is input from the feature extraction unit 405 and reflects tampering information, and presents a portion having different values (i.e., a tampered position) between the two 2D feature images to an image verifier. In FIG. 5, reference numeral 505 denotes an image indicating the difference between the 2D feature images 503 and 504 (an image as a set of different pixel values of corresponding pixels between the 2D feature images 503 and 504). For example, the comparison unit 406 generates the difference image 505, and displays this difference image 505 on the display unit, thus visually presenting the tampered position to the image verifier.

By displaying the 2D feature image 503 calculated from the tampered image and the 2D feature image 504 restored from image region B as a list, not only the tampered position is visually presented to the verifier like the difference image 505, but also the contents of tampering, i.e., the position of a change in 2D feature image from the original image, can be visually and clearly presented to the image verifier.

In FIG. 5, reference numeral 506 denotes an image which is displayed by enlarging the difference image 505 to the size of the tampered image 501, and overlying the enlarged image on the tampered image 501. In this way, the tampered position can be visually and plainly displayed. At this time, if the height and width of the 2D feature image are smaller than those of the input image, the tampered position cannot be strictly specified for respective pixels like in the image 506, but the tampered position detection method of this embodiment is sufficiently effective for serious tampering in practice.

As can be seen from comparison between the method described in article (1) as the prior art and the method according to the first embodiment, the randomize unit 1505 in the prior art implements a function corresponding to the interleaver 105 in this embodiment. Also, functions corresponding to the encryption unit 103 and error-correction encoding unit 104 in the digital watermark embedding apparatus for tampered position detection of this embodiment are not present in article (1) of the prior art.

Likewise, in the tampered position detection apparatus, the derandomize unit 1602 in the prior art implements a function corresponding to the deinterleaver 402 in this embodiment. Also, functions corresponding to the error-correction decoding unit 403 and decryption unit 404 in the tampered position detection apparatus of this embodiment are not present in article (1) of the prior art.

As can be seen from the above description, this embodiment realizes a tampered position detection system which can specify a tampered position more accurately than article (1) of the prior art by adopting the error-correction code, and can assure higher security and convenience than article (1) by adopting the public key cryptosystem.

In this embodiment, the watermark embedding method for tampered position detection and tampered position detection method which adopt “public algorithms” and “can detect the tampered position of an image without any secret information” have been described in detail.

Note that this embodiment cannot detect the presence/absence of tampering in case of slight tampering, i.e., when identical 2D feature images are generated from images before and after tampering. However, the method of this embodiment is an image verification method which can realize robustness that does not detect a slight change as tampering, and is robust against such slight change. Such technique cannot be realized by article (1) of the prior art.

When the presence/absence of tampering must be detected based on a slight change that does not influence an image, such case can be coped with by additional means, e.g., a method of inputting the entire image to a Hash function to calculate a digest (Hash value), encrypting the digest (Hash value) using a private key (to generate a signature), and appending the encrypted digest to a predetermined position such as a header of an image file as a digital signature.

[Second Embodiment]

<Digital Watermark Embedding Apparatus for Tampered Position Detection>

An embedding apparatus according to this embodiment executes a process for further appending a digest (Hash value) calculated using image region A to watermark information generated by the embedding apparatus according to the first embodiment. With this process, not only the tampered position of an image but also the presence/absence of tampering of an image can be determined.

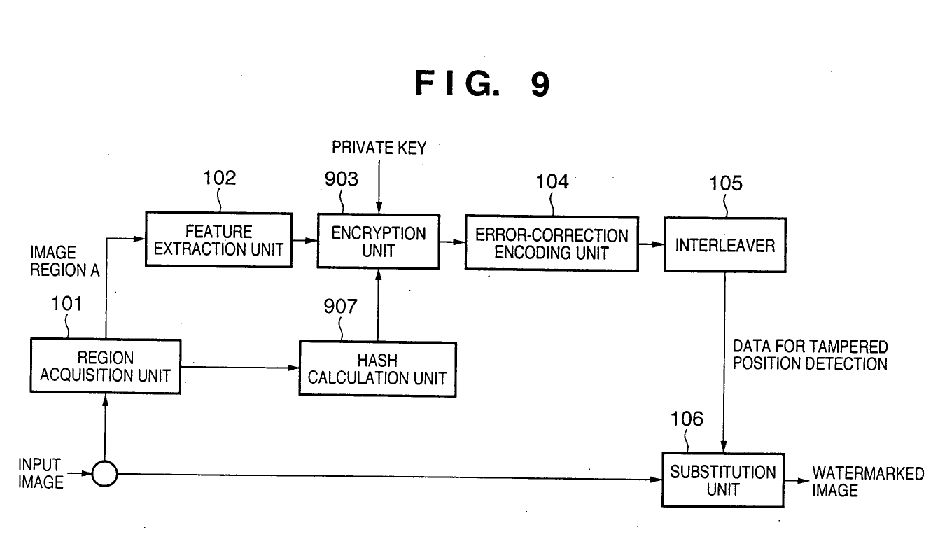

FIG. 9 is a block diagram showing the functional arrangement of a digital watermark embedding apparatus for tampered position detection according to this embodiment. Note that the same reference numerals in FIG. 9 denote the same parts as those in FIG. 1, and a description thereof will be omitted. Respective units shown in FIG. 9 may be implemented by hardware or may be implemented by describing the functions of the respective units as programs, and loading the programs onto a computer.

In FIG. 9, a large difference from FIG. 1 is that a Hash calculation unit 907 is added. An encryption unit 903 generates watermark information described in the first embodiment by executing the same process as that executed by the encryption unit 103, and further appends data of a Hash value generated by the Hash calculation unit 907 to the watermark information.

The digital watermark embedding apparatus for tampered position detection according to this embodiment will be described below using FIG. 9. Note that a description of blocks which execute the same processes as those in the first embodiment will be simplified.

As in the first embodiment, an input image is input to the region acquisition unit 101. The region acquisition unit 101 acquires predetermined image region A from the input image, and outputs that image region to the feature extraction unit 102 and the Hash calculation unit 907. In this embodiment as well, image region A corresponds to bit planes of the upper 7 bits except for a bit plane of the least significant bit (LSB), for the sake of simplicity.

The feature extraction unit 102 extracts a feature of the input image using input image region A, i.e., the bit planes of the upper 7 bits, and outputs a 2D feature image.

The Hash calculation unit 907 inputs image data of image region A to a Hash function to generate a digest, and inputs the digest to the encryption unit 903.

The Hash function will be briefly described below. The Hash function is a function of receiving variable-length data, and calculating and outputting fixed-length data (called a digest or Hash value), and mainly has the following features:

(1) a fixed-length digest is output when an input data length is different;

(2) a largely different digest is output when input data is slightly different;

(3) source input data cannot be generated from a digest; and

(4) it is difficult to detect input data that outputs an identical digest.

Currently, as typical Hash functions, MD2, MD4, MD5, SHA-1, and the like are available. In case of SHA-1, the size of an output digest is 160 bits (20 bytes). In the aforementioned Hash function, when image region A is locally tampered with, an identical digest is unlikely to be generated, and even slight tampering of an image can be easily detected using a digest.

The encryption unit 903 generates watermark information for tampered position detection (803 in FIG. 8) by combining the 2D feature image input from the feature extraction unit 102, the digest input from the Hash calculation unit 907, check bits, and the like. Note that bit fields used to record “width”, “height”, “feature extraction process ID”, and the like described in the first embodiment may be assured as needed.

The encryption unit 903 encrypts the generated watermark information. The encryption unit 903 encrypts the watermark information using a private key (to generate a signature) using the public key cryptosystem as in the first embodiment, and outputs encrypted watermark information C(w).

The encrypted watermark information C(w) is input to the error-correction encoding unit 104. The error-correction encoding unit 104 applies an error-correction encoding process to the input encrypted watermark information C(w), and outputs error-correction encoded, encrypted watermark information ECC(C(w)).

The error-correction encoded, encrypted watermark information ECC(C(w)) is input to the interleaver 105. The interleaver 105 randomly reorders the bit sequence of the input error-correction encoded, encrypted watermark information ECC(C(w)) and outputs randomized error-correction encoded, encrypted watermark information S(ECC(C(w))) to the substitution unit 106. As in the first embodiment, the interleaver 105 is not an indispensable block, and may be omitted when the error-correction encoding unit 104 uses an error-correction code which has error correction performance against tampering (burst error) concentrated at a specific portion, or uses an error-correction code having an interleaver function.

Finally, the error-correction encoded, encrypted watermark information S(ECC(C(w))) randomized by the interleaver 105 is input to the substitution unit 106, which substitutes predetermined image region B (LSB bit plane corresponding to 202 in FIG. 2 in this embodiment) of the input image by the input information, thus outputting a watermarked image embedded with the randomized error-correction encoded, encrypted watermark information S(ECC(C(w))) as an output image.

<Tampered Position Detection Apparatus>

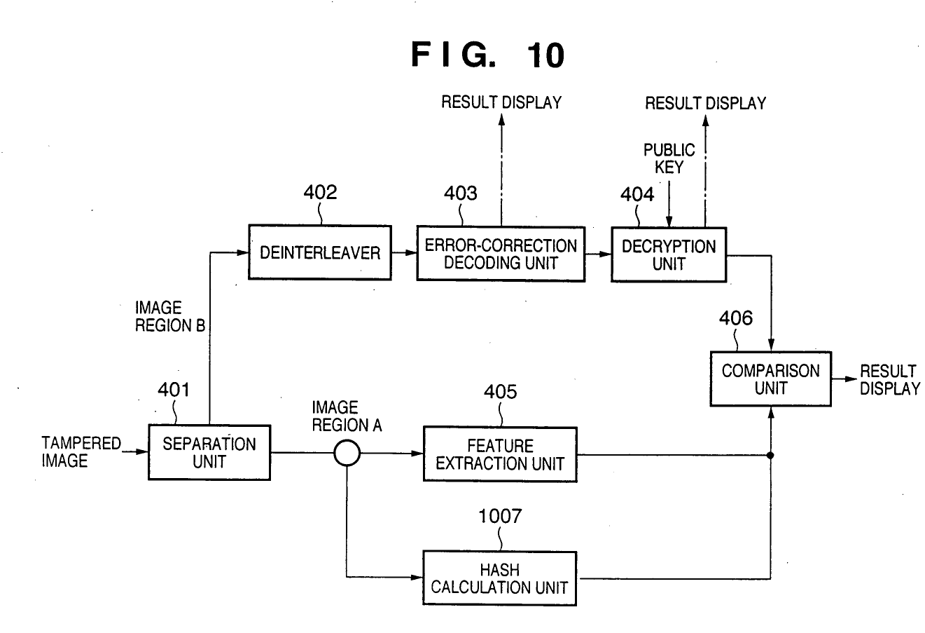

A tampered position detection apparatus according to this embodiment will be described below. FIG. 10 is a block diagram showing the functional arrangement of the tampered position detection apparatus according to this embodiment. Note that the same reference numerals in FIG. 10 denote the same parts as those in FIG. 4, and a description thereof will be omitted. Respective units shown in FIG. 10 may be implemented by hardware or may be implemented by describing the functions of the respective units as programs, and loading the programs onto a computer.

In FIG. 10, a large difference from FIG. 4 is that a Hash calculation unit 1007 is added. Also, a comparison unit 1006 executes a process for notifying the presence/absence of tampering using a digest in addition to the process executed by the comparison unit 406 according to the first embodiment. The tampered position detection apparatus according to this embodiment will be described below using FIG. 10. Note that a description of blocks which execute the same processes as those in the first embodiment will be simplified.

A tampered image (e.g., 501 in FIG. 5) is input to the separation unit 401. The separation unit 401 separates the input image into image region A, and image region B embedded with watermark information for tampered position detection. In this embodiment, image region A corresponds to the bit planes 201 of the upper 7 bits except for the bit plane of the least significant bit (LSB), and image region B corresponds to the LSB bit plane 202, as shown in FIG. 2, as in the embedding apparatus. An image (e.g., 502 in FIG. 5) obtained from image region B at this time may be destroyed at a tampered position due to tampering of the image.

Data of image region B separated by the separation unit 401 is input to the deinterleaver 402. The deinterleaver 402 executes a process for restoring (derandomizing) the bit sequence of partially destroyed, randomized error-corrected encoded encrypted watermark information S′(ECC(C(w))). The deinterleaver 402 outputs the derandomized, partially destroyed, error-correction encoded, encrypted watermark information, i.e., ECC((C(w)), to the error-correction decoding unit 403.

Note that some error-correction codes do not require any interleaver upon embedding. Therefore, the process in the deinterleaver 402 is not indispensable, and is required only when ECC(C(w)) is randomized by the interleaver 105 upon embedding.

ECC′(C(w)) output from the deinterleaver 402 is input to the error-correction decoding unit 403. The error-correction decoding unit 403 makes error-correction decoding of the input partially destroyed ECC′(C(w)) and outputs encrypted watermark information C(w) to the decryption unit 404.

When watermark data in image region B is seriously destroyed by tampering, and the error-correction code cannot normally undergo error-correction decoding, a message “a tampered position cannot be specified, but the entire image has been tampered with” is displayed as a result, thus aborting the process. (In this case, the error-correction code itself must have a function of informing that normal error-correction decoding is disturbed.)

The error-correction decoded encrypted watermark information C(w) input to the decryption unit 404 is decrypted using a public key which is acquired by the public key cryptosystem and corresponds to the private key used in encryption to reclaim watermark information w.

When the watermark information w contains check bits, the decryption unit 404 checks the value of the check bits which form the watermark information w (when the check bits represent a Hash value of a 2D feature image, a Hash value is calculated from the 2D feature image contained in the watermark information w, and is compared with the check bits in the watermark information w to determine whether or not they match), thus identifying whether the encrypted watermark information C(w) is encrypted (undergoes signature generation) using a correct or different private key. If the check bit values do not match, it means that the encrypted watermark information C(w) is not encrypted using a private key used in encryption (signature generation). In such case, the apparatus notifies the user of a message “the image has been illicitly tampered with”, thus ending the process.

The decryption unit 404 extracts a 2D feature image and digest from the decrypted watermark information w (corresponding to 803 in FIG. 8), and outputs them to the comparison unit 1006. The extracted 2D feature image and digest are respectively a similar image to the original image, and the digest calculated by the Hash calculation unit 907.

The feature extraction unit 405 executes a feature extraction process of image region A (the bit planes of the upper 7 bits except for the bit plane of the least significant bit (LSB) in this embodiment) input from the separation unit 401, and outputs a 2D feature image to the comparison unit 1006.

The Hash value calculation unit 1007 inputs the data of image region A input from the separation unit 401 to a Hash function to generate a digest, and outputs the digest to the comparison unit 1006.

Finally, the comparison unit 406 compares the 2D feature image and digest input from the decryption unit 404 with the 2D feature image input from the feature extraction unit 405 and the digest input from the Hash calculation unit 1007.

In the first embodiment, when the difference between the two 2D feature images is small, a message “no tampering that largely change the image contents is found” can be delivered, but whether or not slight tampering is present cannot be determined. However, in this embodiment, a digest of image region A is calculated in addition to the 2D feature image, and when image region A includes a change of even 1 bit, since the two digests assume different values, even slight tampering can be detected by comparing these digests.

When the two 2D feature images to be compared are different from each other, the comparison unit 1006 presents the same result as in the first embodiment to the image verifier. When the two 2D feature images match and the digests match, a message indicating that absolutely no tampering is present is displayed as a result. When the two 2D feature images match but the digests assume different values, a message indicating that undetectable (slight) tampering is present can be displayed as a result.

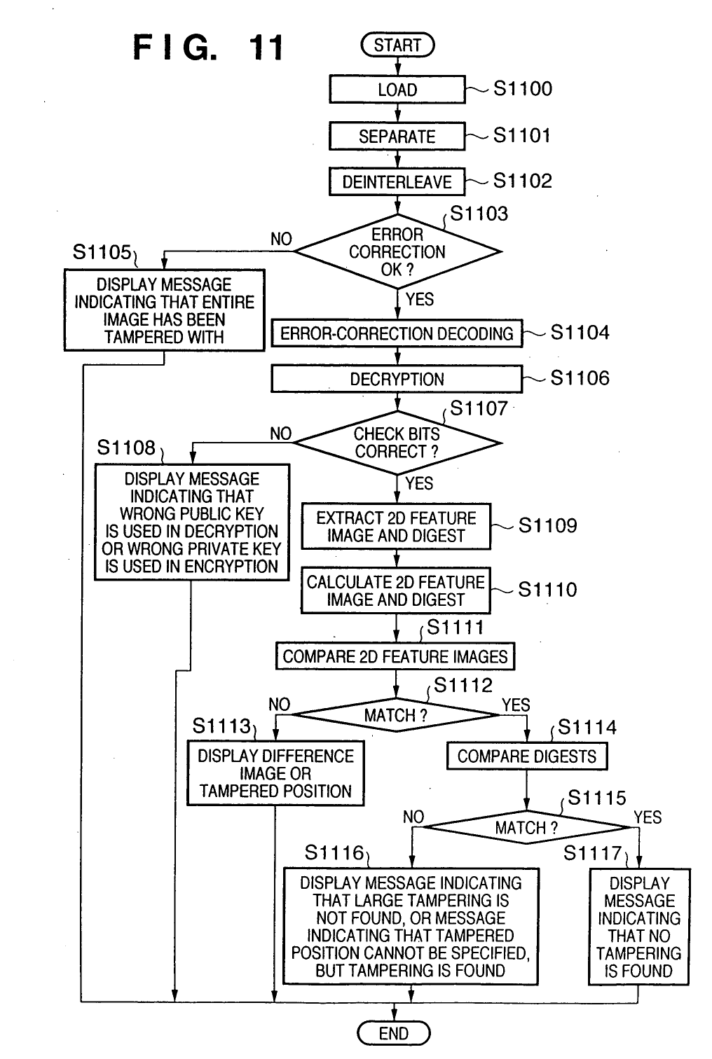

FIG. 11 is a flow chart showing the flow of the tampered position detection process according to this embodiment. The tampered position detection process according to this embodiment will be described in turn using FIG. 11.

In step S1100, a tampered image is input, and various kinds of information (a public key, error-correction encoding parameters, and the like) required to execute tampered position detection are acquired.

In step S1101, the input tampered image is separated into image regions A and B.

In step S1102, data of image region B undergoes a deinterleave process that derandomizes the data, if necessary.

If the error-correction code has a function of determining whether or not error correction can be made, it is checked in step S1103 whether or not error correction can be made. If error correction cannot be made, the flow advances to step S1105 to display a message indicating that the entire image has been tampered with.

If it is determined in step S1103 that error correction can be made, the flow advances to step S1104 to execute an error-correction decoding process to reclaim encrypted watermark information C(w) from the error-correction encoded, encrypted watermark information ECC′(C(w)) destroyed by a tampering process. The flow then advances to step S1106.

In step S1106, the reclaimed encrypted watermark information C(w) undergoes a decryption process using the public key to reclaim watermark information w.

It is checked in step S1107 if check bits in the watermark information w match (if the check bits represent a Hash value of a 2D feature image, a Hash value is calculated from the 2D feature image contained in the watermark information w, and is compared with the check bits in the watermark information w to determine whether or not they match). If the check bits do not match, the flow advances to step S1108 to display a message indicating that a correct public key is not used in decoding or a message indicating that a correct private key is not used in encryption, and the image has been tampered with. (If the error-correction code does not have any function of checking if information can be normally corrected, and error-correction decoding is not normally done, the check bits are not normally decoded in step S1107. In such case, only a message indicating that the image has been tampered with may be displayed.)

If the check bits match in step S1107, the flow advances to step S1109. In step S1109, a 2D feature image and digest are extracted from the watermark information w. In step S1110, a 2D feature image and digest are calculated from image region A.

In step S1111, the 2D feature image extracted from the watermark information in step S1109 is compared with that calculated from image region A in step S1110. It is then checked in step S1112 if the two 2D feature images match. If the two images do not match, the flow advances to step S1113 to display the difference image between the two 2D feature images and the tampered position (503 to 506 in FIG. 5), thus ending the process.

On the other hand, if the two 2D feature images match, the flow advances to step S1114 to compare the digest extracted from the watermark information in step S1109 with that calculated from image region A in step S1110. It is checked in step S1115 if the two digests match. If the two digests do not match, the flow advances to step S1116 to display a message “the image has been tampered with, but tampering is not serious” or “the image has been tampered with, but the tampering position cannot be specified”, thus ending the process.

If the two digests match in step S1115, the flow advances to step S1117 to display a message “the image has not been tampered with” to the verifier, thus ending the process.

In this embodiment, the watermark embedding method for tampered position detection and tampered position detection method which adopt “public algorithms”, “can detect the tampered position of an image without any secret information”, and “can detect the presence/absence of tampering of an image without any secret information” have been described in detail.

In the description of the first and second embodiments, as shown in FIG. 2, the bit planes of the upper 7 bits except for the bit plane of the least significant bit (LSB) are selected as image region A, and the bit plane of the least significant bit (LSB) is selected as image region B. However, the selection method of image regions A and B is not limited to such specific method. For example, image region B may select bit planes of the lower 2 bits, or may select bit planes from an arbitrary bit position in an input image so as not to deteriorate the image quality by embedding a digital watermark for tampered position detection. At this time, image region A is preferably selected not as a region of image region B but as data of an image region where tampering is to be verified.

In the first and second embodiments, an 8-bit grayscale image is assumed as an input image. Alternatively, an RGB color image which is expressed by 8 bits per pixel may be used. In this case, the bit plane of the least significant bit (LSB) of each color may be used as image region B.

In the first and second embodiments, the 2D feature image has been explained as an image which is expressed by 1 bit per pixel. However, the 2D feature image may be a multi-bit image as long as image region B that can store watermark information upon encrypting and error-correction encoding the 2D feature image is available. At this time, the 2D feature image need not be smaller than image region A, and may have a size equal to or larger than image region A.

[Third Embodiment]

In the first and second embodiments, the tampered position detection method in image region A on the basis of the 2D feature image has been explained. In the third embodiment, a tampered position detection method in image region B based on error-correction encoded, encrypted watermark information will be explained.

The third embodiment has the following characteristic feature. That is, when watermark information w is correctly decoded, since it is determined that encrypted watermark information C(w) is also correct, it is determined that source error-correction encoded, encrypted watermark information ECC(C(w)), which is used to obtain the encrypted watermark information C(w) in the error-correction decoding unit 403 and has undergone error correction, is also correct. Hence, by utilizing this fact, error-correction encoded, encrypted watermark information ECC(C(w)) that has undergone error correction is compared with partially destroyed error-correction encoded, encrypted watermark information ECC′(C(w)) to specify a tampered position for each embedding position.

<Digital Watermark Embedding Apparatus for Tampered Position Detection>

The digital watermark embedding apparatus for tampered position detection is the same as that in the first or second embodiment, and a description thereof will be omitted.

<Tampered Position Detection Apparatus>

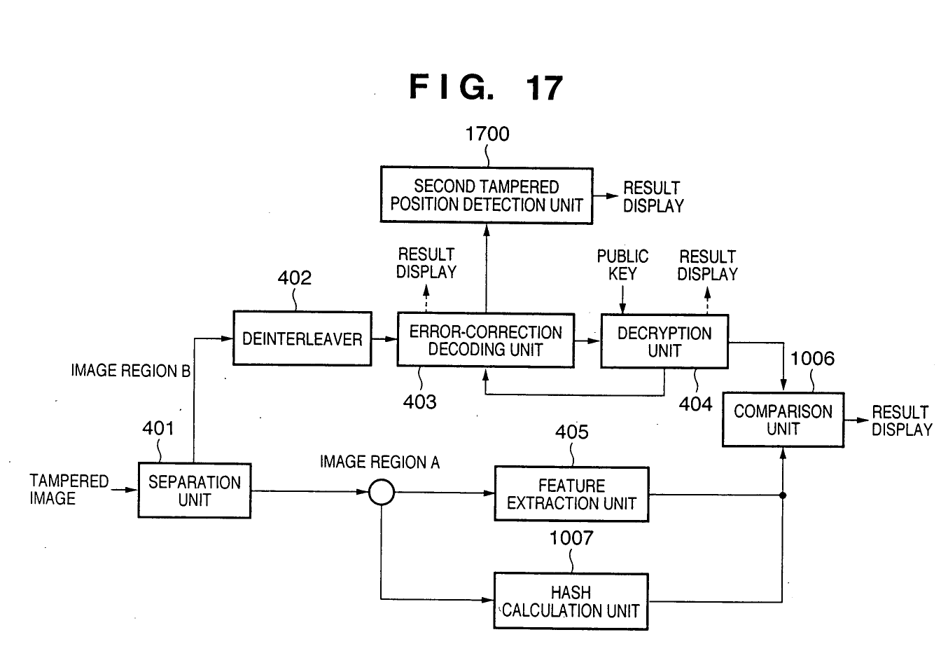

FIG. 17 is a block diagram showing the functional arrangement of a tampered position detection apparatus according to this embodiment. FIG. 17 shows an arrangement in which a second tampered position detection unit 1700 is added to the tampered position detection apparatus according to the second embodiment shown in FIG. 10, and the error-correction decoding unit 403 outputs data to be described later to the second tampered position detection unit 1700 in accordance with an instruction from the decryption unit 404. Note that the same reference numerals in FIG. 17 denote the same parts as those in FIGS. 4 and 10. Respective units shown in FIG. 17 may be implemented by hardware or may be implemented by describing the functions of the respective units as programs, and loading the programs onto a computer.

The tampered position detection apparatus with the functional arrangement shown in FIG. 17 will be described in detail below. Also, an arrangement obtained by adding the second tampered position detection unit 1700 to the tampered position detection apparatus (FIG. 4) in the first embodiment may be used.

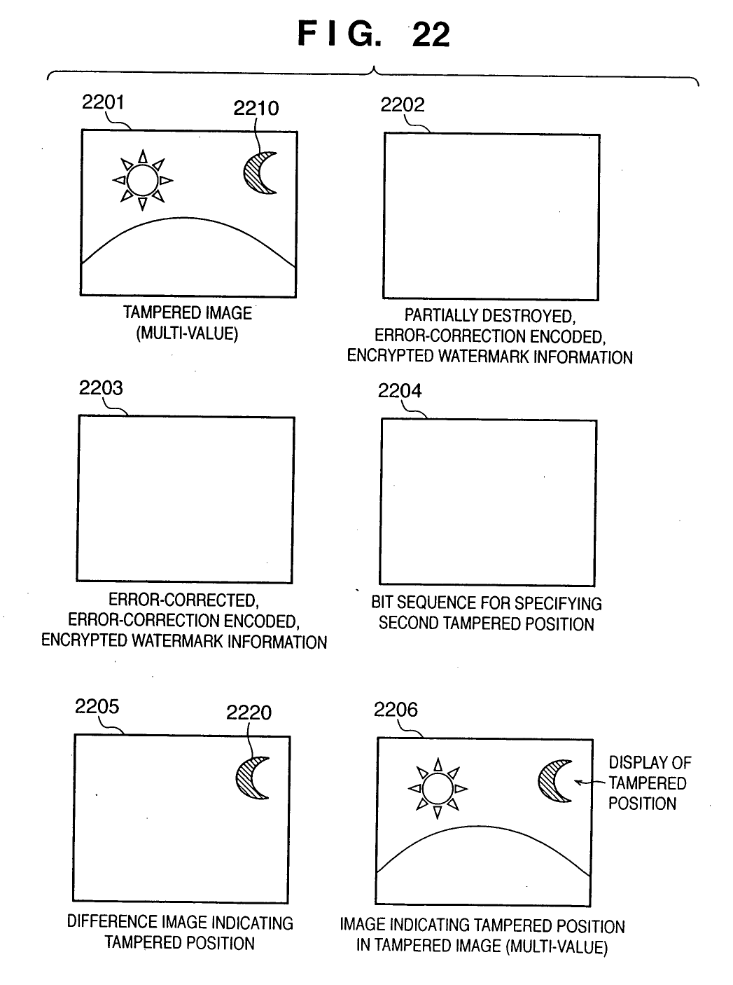

FIG. 22 is a view for explaining a process for detecting a tampered position from a tampered image. The process to be executed by the tampered position detection apparatus will be described below using FIG. 22 with reference to the block diagram of FIG. 17.

Referring to FIG. 22, reference numeral 2201 denotes a tampered image, which has a tampered region 2210 (a hatched crescent region). In the following description, the tampered image 2201 will be exemplified, but the process to be described hereinafter can be applied to various other tampered images.

The tampered image 2201 (input image) is input to the separation unit 401 so as to verify a tampered position. The separation unit 401 separates the input image into image region A, and image region B embedded with watermark information for tampered position detection. In this embodiment as well, image region A corresponds to the bit planes 201 of the upper 7 bits except for the bit plane of the least significant bit (LSB), and image region B corresponds to the LSB bit plane 202, as shown in FIG. 2, as in the above embodiments. As has already been described above, image region B is embedded with watermark information for tampered position detection.

An image (e.g., 502 in FIG. 5) obtained from image region B at this time may be destroyed at a tampered position 520 due to tampering of the image.

Data of image region B separated by the separation unit 401 is input to the deinterleaver 402. The deinterleaver 402 executes a deinterleave process for restoring the arrangement of the bit sequence which forms partially destroyed, randomized error-corrected encoded encrypted watermark information S′(ECC(C(w))).

The deinterleaver 402 generates the partially destroyed, error-correction encoded, encrypted watermark information which has undergone the deinterleave process, i.e., ECC′(C(w)), and outputs that information to the error-correction decoding unit 403.

In FIG. 22, reference numeral 2202 denotes a 2D image that expresses the partially destroyed, error-correction encoded, encrypted watermark information ECC′(C(w)), which is obtained by applying the deinterleave process to image region B (502 in FIG. 5). Bit information destroyed by tampering spreads over the entire image 2202.

Note that some error-correction codes do not require any interleaver upon embedding. Therefore, the deinterleave process in the deinterleaver 402 is not indispensable, and is required only when ECC(C(w)) undergoes the interleave process by the interleaver 105 upon embedding.

The error-correction decoding unit 403 makes error-correction decoding of the input partially destroyed ECC′(C(w)) and outputs encrypted watermark information C(w) to the decryption unit 404.

When watermark data in image region B is seriously destroyed by tampering, and the error-correction encoded, encrypted watermark information ECC′(C(w)) cannot normally undergo error-correction decoding, a message “a tampered position cannot be specified, but the entire image has been tampered with” is displayed as a result, thus aborting the process (in this case, the error-correction code itself must have a function of informing that normal error-correction decoding is disturbed).

In general, the error-correction decoding unit 403 corrects any error of the partially destroyed, error-correction encoded, encrypted watermark information ECC′(C(w)) using a rule used upon error-correction encoding to generate error-corrected, error-correction encoded, encrypted watermark information ECC(C(w)). Then, the unit 403 executes a process for extracting encrypted watermark information C(w) as source information from the error-correction encoded, encrypted watermark information ECC(C(w)).

In FIG. 22, reference numeral 2203 denotes a 2D image that expresses the error-correction encoded, encrypted watermark information ECC(C(w)) obtained by correcting any error of the partially destroyed, error-correction encoded, encrypted watermark information ECC′(C(w)) (2202).

In this embodiment, assume that the error-correction decoding unit 403 holds the partially destroyed, error-correction encoded, encrypted watermark information ECC′(C(w)), and the error-corrected, error-correction encoded, encrypted watermark information ECC(C(w)), after it outputs the error-correction decoded encrypted watermark information C(w) to the decryption unit 404.

Also, in this embodiment, upon reception of a control signal from the decryption unit 404, the error-correction decoding unit 403 outputs the partially destroyed, error-correction encoded, encrypted watermark information ECC′(C(w)), and the error-corrected, error-correction encoded, encrypted watermark information ECC(C(w)) to the second tampered position detection unit 1700.

The decryption unit 404 decrypts the input error-correction decoded, encrypted watermark information C(w) to reclaim watermark information w. When the encrypted watermark information C(w) is encrypted by the public key cryptosystem, the unit 404 acquires a public key corresponding to the private key used in encryption, and executes a decryption process using that public key.

At this time, in this embodiment as well, the decryption unit 404 verifies whether or not the watermark information w is correct, as in the first and second embodiments. In this embodiment, whether or not the entire watermark information w is correct is verified. Therefore, check bits are not those which are required to verify consistency of some components of the watermark information but are those which are required to verify consistency of the whole watermark information w except for the check bits themselves.

The method of verifying the consistency of the watermark information w using the check bits has already been explained in the first and second embodiments. As for the basic verification method, the same applies to this embodiment. That is, when the check bits represent a Hash value of watermark information except for the check bits, a Hash value obtained by inputting the watermark information except for the check bits to a Hash function is compared to the value of the check bits as a part of the watermark information, thus verifying the consistency of the entire watermark information.

When the encryption unit 903 in the digital watermark embedding apparatus for tampered position detection encrypts watermark information using a block cryptosystem (that implements encryption for respective blocks), watermark information w is normally segmented into blocks (each having a key length), and is then encrypted for respective blocks. However, when a segmented block has an information size less than the key length, predetermined values (e.g., zeros) are padded, and that block then undergoes the encryption process. For example, the RSA cryptosystem as one of the public key cryptosystems belongs to the block cryptosystem, and executes an encryption process for respective blocks.

In such case, in order to verify if the encrypted watermark information C(w) generated by appending the padding value to the watermark information w is correct, whether or not the padding value appended upon encrypting the watermark information w is consistent must be checked upon decryption. In such case, the padding value is preferably processed in the same manner as the watermark information w. That is, in the digital watermark embedding apparatus for tampered position detection, the check bits represent a Hash value or a check sum for the watermark information except for the check bits themselves and the padding value. The decryption unit 404 of the tampered position detection apparatus compares the check bit value calculated from the watermark information except for the check bits themselves and the padding value with the check bit value in the watermark information, so as to verify the consistency of the watermark information.

For the sake of simplicity, a description of the process executed when the padding value is present will be omitted.

In general, in order to complicate decryption, output data is designed to randomly change with respect to a slight change in input data, and it is difficult to estimate correspondence between the input and output data unless key information is available. Therefore, in this embodiment as well, it is very difficult to intentionally generate false encrypted watermark information while maintaining the consistency between the watermark information and check bits, unless a private key used in encryption (a private key in the public key cryptosystem or a common key in the common key cryptosystem) is known.

Therefore, as long as the security of the cryptosystem used in encryption is guaranteed, it is allowed in practice to determine that the encrypted watermark information C(w) has been tampered with, if the consistency between the watermark information and check bits is not found, and to determine that the encrypted watermark information C(w) has not been tampered with, if the consistency between the watermark information and check bits is found.

In this embodiment, if the watermark information w is consistent, it is determined that the encrypted watermark information C(w) and error-corrected, error-correction encoded, encrypted watermark information ECC(C(w)) used to obtain the encrypted watermark information C(w) are also correct. Therefore, the verifier can detect the error-correction encoded, encrypted watermark information ECC(C(w)) used in embedding without acquiring any private key.

In the first and second embodiments, as has been described briefly, the error-correction decoding unit 403 outputs correct encrypted watermark information C(w). However, in practice, the encrypted watermark information output from the error-correction decoding unit 403 is not always equal to original correct encrypted watermark information C(w).

For example, assume that when parameters used in the encoding process of the error-correction encoding unit 104 are open to the public, a counterfeiter generates false error-correction encoded, encrypted watermark information by making error-correction encoding of false encrypted watermark information to allow error-correction decoding of the error-correction decoding unit 403, and replaces it by image region B. At this time, the error-correction decoding unit 403 of the tampered position detection apparatus simply makes error-correction decoding, and outputs false encrypted watermark information.

Also, as a result of some tampering, error-correction encoded, encrypted watermark information ECC(C′(w)) corresponding to error-correction encoded information of wrong encrypted watermark information C′(w) may be accidentally generated.

When the error-correction code itself has no function of detecting if error correction can be made, the error-correction decoding unit 403 may simply make error-correction decoding of the input information based on a rule, and may output encrypted watermark information C′(w) which is different from the original encrypted watermark information C(w).

As described above, the error-correction decoding unit 403 outputs wrong encrypted watermark information C′(w) in various cases.

However, in this embodiment, after the decryption unit 404 decrypts the encrypted watermark information, it verifies the consistency of the watermark information using the check bits, thus detecting tampering of the watermark information.

For example, when the check bits represent a Hash value of watermark information except for the check bits, the decryption unit 404 compares a Hash value obtained by inputting the watermark information except for the check bits to a Hash function with the value of the check bits as a part of the watermark information. If they do not match, it is determined that watermark information and encrypted watermark information are false, i.e., they have been tampered with. In this case, a message indicating that a tampered position cannot be specified, but the image has been tampered with, or a message indicating that the entire image has been tampered with since tampering has spread over the entire image may be displayed.

As has been described in the first and second embodiments, when encrypted watermark information C(w) is generated by encryption using a private key (e.g., pri2) which is different from a private key (e.g., pri1) to be normally used in encryption (signature generation), that information cannot be normally decrypted if decryption is done using a public key (pub1) corresponding to the private key (pri1) to be used. Therefore, even when the consistency of the watermark information is verified using the check bits, some error of watermark information is detected. In this case as well, it is similarly determined that the image has been tampered with, and a message indicating that a tampered position cannot be specified, but the image has been tampered with, or a message indicating that the entire image has been tampered with since tampering has spread over the entire image may be displayed.

Also, when the encrypted watermark information C(w) is decrypted using a public key which does not correspond to the private key used in encryption (signature generation) by mistake, the check bit values do not match. In this case, a message “a wrong key is used in decryption of encrypted watermark information” may be displayed for the image verifier. However, in general, the image verifier must be careful about misuse of a key required to decrypt encrypted information. Hence, when the decryption unit 404 cannot specify that a wrong key is used in decryption of encrypted watermark information, it may determine that the image has been tampered with, and may display a message indicating that a tampered position cannot be specified, but the image has been tampered with, or a message indicating that the entire image has been tampered with since tampering has spread over the entire image.

As a result of verification of watermark information using the check bits in the internal process of the decryption unit 404, if the check bit value in the watermark information matches that (e.g., a Hash value or check sum) calculated from the watermark information except for the check bits, the decryption unit 404 sends a control signal to the error-correction decoding unit 403.

Upon reception of the control signal from the decryption unit 404, the error-correction decoding unit 403 outputs the partially destroyed, error-correction encoded, encrypted watermark information ECC′(C(w)), and the error-corrected, error-correction encoded, encrypted watermark information ECC(C(w)) to the second tampered position detection unit 1700.

Therefore, in this embodiment, even when error-correction decoding is simply successful in the error-correction decoding unit 403, the second tampered position detection unit 1700 does not detect a tampered position.

As has been described above, if error-correction decoding is successful in the error-correction decoding unit 403, the error-correction decoding unit 403 does not always output correct encrypted watermark information C(w), and may output wrong encrypted watermark information C′(w). This is because output data from the error-correction decoding unit 403 has poor reliability, and tampered position detection based on such data also has poor reliability.

On the other hand, it is very difficult to tamper with information while satisfying the consistency of watermark information w without any knowledge about a private key (a private key in the public key cryptosystem or a common key in the common key cryptosystem), in terms of the principle of cryptograph. Therefore, if the consistency of the watermark information w can be verified, it is considered that the encrypted watermark information C(W) is reliable data, and error-correction encoded, encrypted watermark information ECC(C(w)) obtained by error-correction encoding the reliable encrypted watermark information C(W) is also reliable.

For this reason, when the error-corrected, error-correction encoded, encrypted watermark information ECC(C(w)) is compared with the partially destroyed, error-correction encoded, encrypted watermark information ECC′(C(w)) after the consistency of the watermark information w is verified, a tampered position can be accurately specified.

The decryption unit 404 then extracts a 2D feature image and digest from the decrypted watermark information w (corresponding to 803 in FIG. 8), and outputs them to the comparison unit 1006. The extracted 2D feature image and digest are respectively a similar image to the original image, and the digest calculated by the Hash calculation unit 907.

The subsequent operations of the feature extraction unit 405, Hash calculation unit 1007, and comparison unit 1006 are the same as those in the second embodiment.

The feature extraction unit 405 executes a feature extraction process of image region A (the bit planes of the upper 7 bits except for the bit plane of the least significant bit (LSB) in this embodiment) input from the separation unit 401, and outputs a 2D feature image to the comparison unit 1006.

The Hash value calculation unit 1007 inputs the data of image region A input from the separation unit 401 to a Hash function to generate a digest, and outputs the digest to the comparison unit 1006.

The comparison unit 406 compares the 2D feature image and digest input from the decryption unit 404 with the 2D feature image input from the feature extraction unit 405 and the digest input from the Hash calculation unit 1007.

When the two 2D feature images to be compared are different from each other, the comparison unit 1006 presents the same result as in the first embodiment to the image verifier. When the two 2D feature images match and the digests match, a message indicating that absolutely no tampering is present is displayed as a result. When the two 2D feature images match but the digests assume different values, a message indicating that undetectable (slight) tampering is present in image region A can be displayed as a result.

This embodiment further implements tampered position detection in image region B using the second tampered position detection unit 1700 in addition to that in image region A described in the first and second embodiments. The second tampered position detection unit 1700 will be described in detail below.

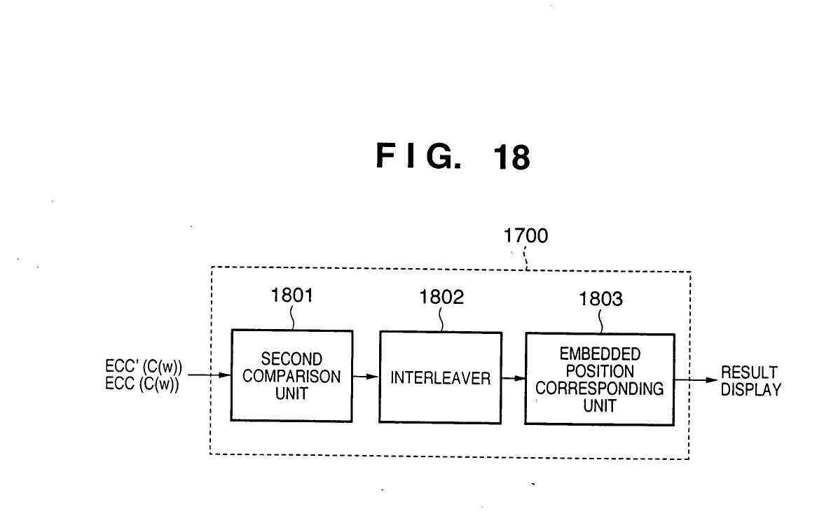

FIG. 18 is a block diagram showing the functional arrangement of the second tampered position detection unit 1700. The second tampered position detection unit 1700 comprises a second comparison unit 1801, interleaver 1802, and embedded position corresponding unit 1803. Respective blocks will be explained below.

The second comparison unit 1801 receives the error-corrected, error-correction encoded, encrypted watermark information ECC(C(w)) and partially destroyed, error-correction encoded, encrypted watermark information ECC′(C(w)) from the error-correction decoding unit 403.

To restate, when the consistency of the watermark information w has already been verified, it is determined that the encrypted watermark information C(w) and error-corrected, error-correction encoded, encrypted watermark information ECC(C(w) are respectively equal to those generated by the digital watermark embedding apparatus for tampered position detection.

The second comparison unit 1801 compares the input two bit sequences, i.e., the partially destroyed, error-correction encoded, encrypted watermark information ECC′(C(w)) and error-corrected, error-correction encoded, encrypted watermark information ECC(C(w)) for respective bits.

If the two bit sequences consist of bits 1 or 0, simple comparison between the two bit sequences can be realized by calculating XOR (exclusive OR) values of bits located at the same positions in the two bit sequences. If bits located at the same position in the two bit sequences assume the same value, an XOR value=0; if they assume different values, an XOR value=1. A bit sequence (second tampered position specifying bit sequence BS) formed by arranging the XOR values of the corresponding bits in the two bit sequences is calculated in this way, and is output to the interleaver 1803. The second tampered position specifying bit sequence BS normally indicates the positions of bits which assume different bit values in the two bit sequences.

In FIG. 22, reference numeral 2204 denotes a 2D image which expresses the second tampered position specifying bit sequence BS, and indicates the distribution (positions) of different bit values between partially destroyed, error-correction encoded, encrypted watermark information 2202 in FIG. 22 and the error-corrected, error-correction encoded, encrypted watermark information 2203. In the image 2204, bits destroyed by tampering are distributed over the entire image.

The interleaver 1802 reorders the arrangement of the input second tampered position specifying bit sequence BS to generate an interleaved second tampered position specifying bit sequence S(BS), and outputs it to the embedded position corresponding unit 1803.

The process executed by the interleaver 1802 at that time is the same as that of the interleaver 105 in the digital watermark embedding apparatus for tampered position detection. To recapitulate, the process of the interleaver 1802 is not indispensable, but is required only when the digital watermark embedding apparatus for tampered position detection uses the interleaver.

The embedded position corresponding unit 1803 determines correspondence between embedded positions in the interleaved second tampered position specifying bit sequence S(BS) and the input image (tampered image).

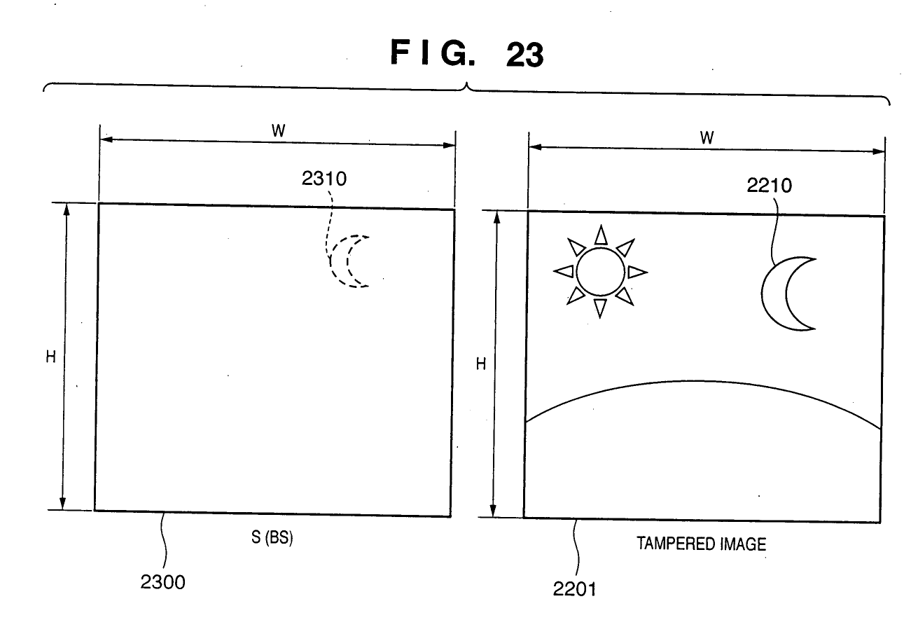

FIG. 23 shows the correspondence between the second tampered position specifying bit sequence S(BS) and tampered image. By arranging the second tampered position specifying bit sequence S(BS) as a linear bit sequence in a 2D matrix, a left 2D bit matrix 2300 in FIG. 23 is obtained. That is, if the tampered image 2201 has a size of H pixels (height)×W pixels (width), the second tampered position specifying bit sequence S(BS) is arranged in turn from the first bit in a matrix of H pixels (height)×W pixels (width), thus obtaining the 2D bit matrix 2300. By generating such 2D bit matrix 2300, bit values “1” are set in a region 2301 corresponding to the tampered region 2210 in the right tampered image 2201 in FIG. 23, and bit values “0” are set in the remaining region. Hence, by referring to pixels in the tampered image 2201 corresponding to bit positions with bit values “1” in the 2D bit matrix 2300, a set of the referred pixels forms the tampered region (2210).

In FIG. 22, reference numeral 2205 denotes an image which explicitly indicates the tampered region 2210 in the interleaved second tampered position specifying bit sequence S(BS). In the image 2204, bits destroyed by tampering are distributed over the entire image. However, on the image 2205, bits destroyed by tampering are concentrated on the tampered region 2210. Finally, the second tampered position detection unit 1700 displays the tampered position, thus ending the process. At this time, a difference image indicating the tampered position (e.g., the image 2205) may be displayed, as has been explained in the first and second embodiments, or the difference image (e.g., the image 2205) may be overlaid on the input image to indicate the tampered position like an image 2206 in FIG. 22.

When the resolution of the 2D feature image (the size of the image) is lower than that of the tampered image, the tampered position detection result (image 2206 in FIG. 22) in this embodiment can specify the tampered position at a higher resolution (for respective embedded positions) than that (image 506 in FIG. 5) in the first and second embodiments.

The process of the second tampered position detection unit 1700, which compares the deinterleaved, partially destroyed, error-correction encoded, encrypted watermark information ECC′(C(w)) with the error-corrected, error-correction encoded, encrypted watermark information ECC(C(w)), and specifies the tampered position has been explained in detail.

In the description of this embodiment, the error-correction decoding unit 403 generates the error-corrected, error-correction encoded, encrypted watermark information ECC(C(w)). Alternatively, when the error-correction decoding unit 403 outputs the encrypted watermark information C(w) alone, and does not externally output any error-corrected, error-correction encoded, encrypted watermark information ECC(C(w)), the encrypted watermark information C(w) output from the error-correction decoding unit 403 may undergo error-correction encoding again to generate error-corrected, error-correction encoded, encrypted watermark information ECC(C(w)).

When the watermark information w meets the consistency, it can be determined that both the encrypted watermark information C(w) and the error-correction encoded, encrypted watermark information ECC(C(w)) are also correct.

By comparing the error-correction encoded, encrypted watermark information ECC(C(w)) obtained by making error-correction encoding of the encrypted watermark information C(w) again with the partially destroyed, error-correction encoded, encrypted watermark information ECC′(C(w)), the tampered position can be accurately specified as in the above description.

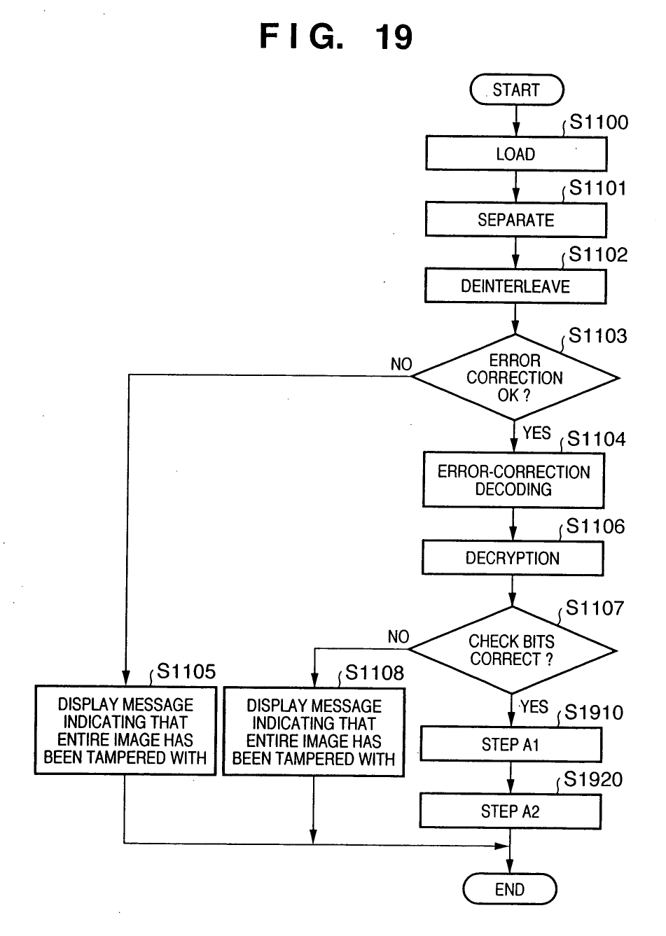

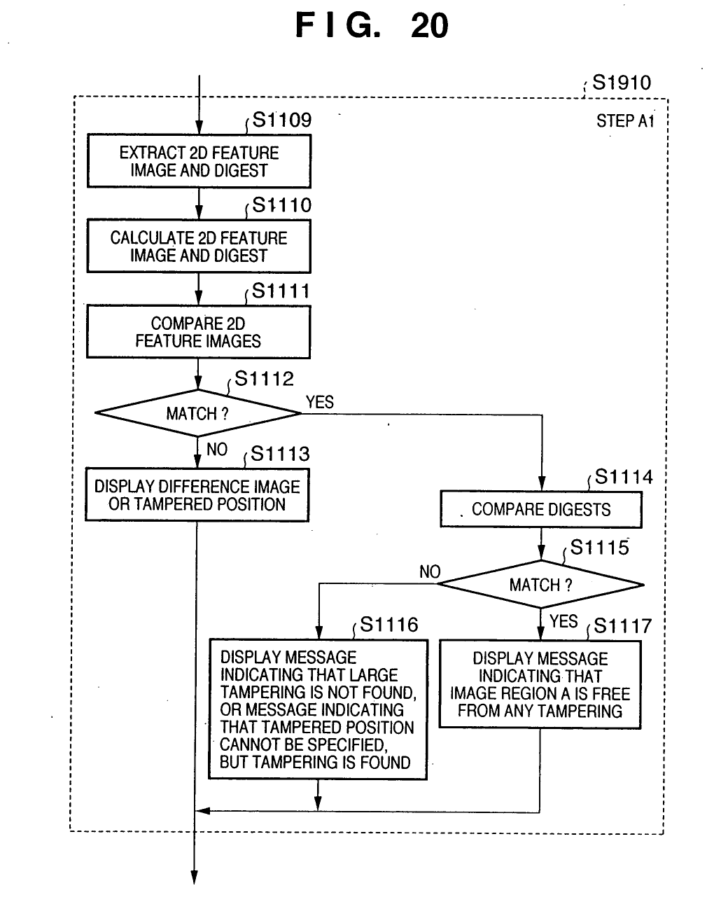

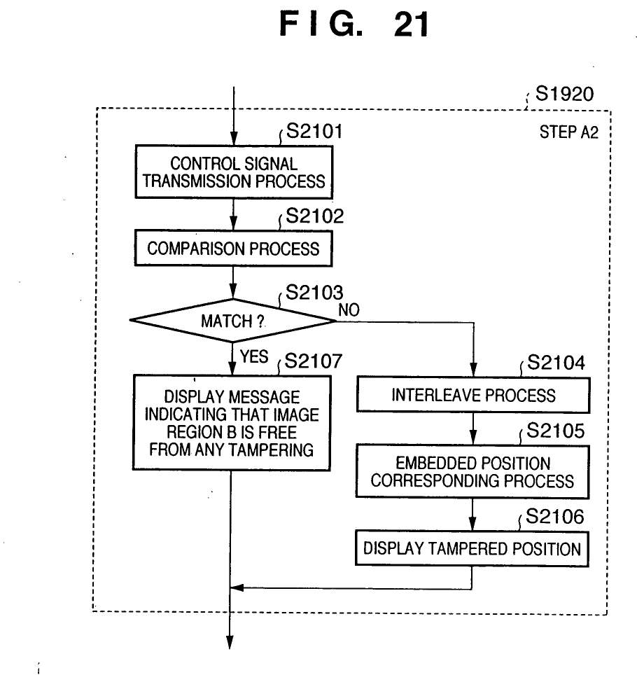

FIG. 19 is a flow chart showing the flow of the tampered position detection process according to this embodiment. FIG. 20 is a flow chart showing details of step A1 (step S1910) in FIG. 19, and FIG. 21 is a flow chart showing details of step A2 (step S1920) in FIG. 19.

The tampered position detection process according to this embodiment will be described below using FIGS. 19, 20, and 21. Note that the same step numbers in FIGS. 19 and 20 denote the same processes as those in FIG. 11.

Since the processes in steps S1100 to S1106 have already been described in detail in the first and second embodiments, a description thereof will be omitted.

In step S1107, the consistency of the watermark information w is verified using the check bits in the watermark information w. If the check bits do not match in step S1107 (the watermark information w does not meet consistency), the flow advances to step S1108 to display a message indicating that the image has been tampered with or a message indicating that the private key used in encryption (signature generation) does not correspond to the public key used in decryption.

If the check bits match in step S1107, the flow advances to step A1 (step S1910). Since details of the process in step A1 (step S1910) are the same as the processes in steps S1109 to S1117 in FIG. 11, and have been explained in the second embodiment, a description thereof will be omitted.

Upon completion of the process in step A1 (step S1910), the flow advances to step A2 (step S1920). In step A2 (step S1920), the process of the second tampered position detection unit 1700 in FIG. 17 is executed.

Since the consistency of the watermark information w and encrypted watermark information C(w) has already been confirmed in step S1107, a control signal transmission process in step S2101 sends a control signal from the decryption unit 404 to the error-correction decoding unit 403.

Upon reception of this control signal, the error-correction decoding unit 403 outputs the partially destroyed, error-correction encoded, encrypted watermark information ECC′(C(w)) and error-corrected, error-correction encoded, encrypted watermark information ECC(C(w)) to the second tampered position detection unit 1700.

In the comparison process in step S2102, the bit sequence of the partially destroyed, error-correction encoded, encrypted watermark information ECC′(C(w)), which has already been deinterleaved in step S1102, is compared with that of the error-correction encoded, encrypted watermark information ECC(C(w)), which has been error-corrected in step S1104, thus generating the second tampered position specifying bit sequence BS.

It is checked in step S2103 if the two bit sequences match. If the two bit sequences match (e.g., if XOR values of bits at corresponding positions in the two bit sequences are calculated for all bit pairs, and all XOR values are “0”), the flow advances to step S2107 to display a message indicating that image region B is free from any tampering, thus ending the process of the tampered position detection apparatus.

If the two bit sequences do not match (e.g., if XOR values of bits at corresponding positions in the two bit sequences are calculated for all bit pairs, and at least one XOR value is “1”), the flow advances to step S2104.

In step S2104, the second tampered position specifying bit sequence BS undergoes an interleave process for reordering the arrangement of the bit sequence to generate an interleaved second tampered position specifying bit sequence S(BS).

Note that the interleave process in step S2104 is required only when the digital watermark embedding apparatus for tampered position detection comprises the interleaver 105, and that interleaver 105 executes an interleave process of the error-correction encoded, encrypted watermark information ECC(C(w)).

In step S2105, a position corresponding process for determining correspondence between the bits of the interleaved second tampered position specifying bit sequence S(BS) and positions in the input image is executed.

In step S2106, the tampered position is displayed in correspondence with the position in the input image. As has been explained in the first and second embodiments, the tampered position may be overlaid on the input image, and the display method is not particularly limited.

Upon completion of the process in step S2106, the process of the tampered position detection apparatus ends.

In FIG. 19, the processes are done in the order of steps A1 and A2. However, the order of the processes in steps A1 and A2 may be reversed. That is, the processes may be done in the order of steps A2 and A1.

The processes in steps S1113, S1116, S1117, S2107, and S2106 are independently executed in this embodiment. Alternatively, an integrated result may be presented.

For example, an overview of tampering of the entire image may be presented using the tampered position (calculated from the 2D feature image) specified in step S1113, and an accurate tampered position may be presented using the tampered position (calculated from the second tampered position specifying bit sequence BS) specified in step S2106. Also, the tampered position of image region A specified in step S1113 and that of image region B specified in step S2106 may be displayed together.

In the first and second embodiments, since the tampered position is detected on the basis of the 2D feature image, when the 2D resolution of the 2D feature image is lower than that of the input image, the tampered position is specified at the resolution of the 2D feature image. Also, the tampered position is specified for image region A but not for image region B.

However, when the method according to this embodiment is used, the tampered position can be accurately detected for respective embedded position in image region B irrespective of the resolution of the 2D feature image.

Therefore, in addition to the features of the first and second embodiments:

(1) robust tampered position detection in image region A using a 2D feature image; and

(2) detection of the presence/absence of tampering in image region A using a digest, the third embodiment can realize:

(3) tampered position detection for respective embedded positions in image region B.

Note that this embodiment has exemplified a case wherein watermark data for tampered position detection is embedded in the LSB of an 8-bit grayscale image. However, the embedded position of the watermark data for tampered position detection is not limited to the LSB.

As will be described later in the seventh and eighth embodiments, the method of this embodiment can be applied to a JPEG compression-encoded image, JPEG2000 compression-encoded image, and the like as typical compression-encoded images.

For example, quantized discrete cosine transformation (DCT) coefficients or discrete wavelet transformation (DWT) coefficients in a JPEG compression-encoded image or JPEG2000 compression-encoded image are quantized, so that quantized coefficients become an odd or even multiple of a predetermined constant, thus embedding bit information of 0 or 1. For example, when the value of an arbitrary coefficient is “5”, and “1” is to be embedded in this coefficient, a quantized value (first quantized value) that can yield an odd quotient may be used. On the other hand, when “0” is to be embedded in this coefficient, a quantized value (second quantized value) that can yield an even quotient may be used. As examples of such first and second quantized values, “2” is typical, but the respective quantized values may use different values.

When watermark information for tampered position detection is embedded in frequency coefficients of an image in this way, detection of a tampered position based on the quantized frequency coefficients can be implemented.

Since a feature of the tampered position detection apparatus described in this embodiment lies in that the tampered position of image region B can be detected as long as the consistency of the watermark information can be confirmed, information which is not related to an image may be used as watermark information.

For example, watermark information may be formed of predetermined information and check bits of that information. As watermark information, fixed information which is determined in advance in a tampered position detection system may be used. If the decryption unit checks if the extracted watermark information matches the predetermined information and confirms the consistency of the watermark information, the user of the tampered position detection apparatus can confirm that the watermark information is free from tampering. Since the watermark information contains neither feature image information nor a Hash value of image region A, the process in step A1 in FIG. 19 is omitted. By executing the process in step A2, the tampered position in image region B can be detected. Such modification can also sufficiently serve as a tampered position detection apparatus.

If watermark information has a small information size, encrypted watermark information can undergo redundant error-correction encoding to fall in image region B. Therefore, even when most of an image have been tampered with, error-correction decoding can be made, and the robustness against tampering, i.e., the tampered position specifying performance can be improved.

[Fourth Embodiment]

The first to third embodiments have mainly exemplified a case wherein the 2D feature image is expressed by 1 bits per pixel. However, in some types of images, a multi-level image (e.g., 8 bits per pixel) can often express an original image better than a high-resolution image (1 bit per pixel; an image with a large number of pixels). In this embodiment, the process of the feature extraction unit may generate a multi-level image.

For example, in the first embodiment, the feature extraction unit generates a 2D feature image which has a size of 256 pixels (height)×256 pixels (width) and is expressed by 1 bit per pixel. However, in this embodiment, an image which has a size of 128 pixels (height)×128 pixels (width) and is expressed by 4 bits per pixel may be generated. At this time, the watermark information has the same data size in these embodiments.

In order to cope with a multi-level 2D feature image, the watermark information w may have a field for recording “the number of gray levels” of the 2D feature image (804 in FIG. 8) to define the arrangement of data of the 2D feature image. Thus, a multi-level 2D feature image can be reclaimed from the watermark information. Although not shown, the watermark information may have a field for recording “color information” or the like which forms the 2D feature image. Therefore, the watermark information can adopt a format similar to a popular image format (e.g., TIFF, JPEG, or the like).

As an example of the process for generating a multi-valued 2D feature image, various processes such as a reduction process for the input image, a process for acquiring low-frequency components after a discrete wavelet transformation process, and the like may be used. As described above, when the feature extraction process used is described in the feature extraction process ID in the watermark information, the tampered position detection apparatus can determine a feature extraction process to be executed by the feature extraction unit on the basis of the feature extraction process ID in the watermark information w extracted from a tampered image. For this reason, when the feature extraction unit in the tampered position detection apparatus executes feature extraction based on the feature extraction process ID, tampered position detection can be made.

[Fifth Embodiment]

The fifth embodiment will explain a data size reduction method of a 2D feature image. Upon detecting a tampered position from an image, even when a region other than a specific region of interest has been tampered with, such tampering need not be detected in some cases. For example, only a license plate region in a vehicle image is set as a region of interest, and undergoes detection of the presence/absence of tampering and tampered position.

In this case, when a 2D feature image is calculated from information of the entire image, and the calculated 2D feature image is set in watermark information w, the information size is inefficiently large. In such case, the most important region is extracted from the 2D feature image, and an image of the extracted region (partial image) may be set in the watermark information w as a 2D feature image. Although not shown, the watermark information preferably has a format that can record information indicating that images each having a size of px (height)×py (width) (the partial image has a size of Px (height)×Py (width)) are extracted from the coordinate position (a1, a2) of the upper left corner of the partial image by 8 bits per pixel.

For example, when watermark information is to be automatically embedded in an image sensed by a digital camera, a predetermined rectangular region having an in-focus position as the center need only be set as the partial image, thus greatly reducing the data size of the 2D feature image in the watermark information w.

Furthermore, since the 2D feature image is image data, the obtained 2D feature image may undergo various compression processes, and the compressed 2D feature image may be set in the watermark information w.

Since the aforementioned 2D feature image extraction process is recorded in the watermark information w as the feature extraction process ID, a similar 2D feature image can be generated upon tampered position detection.

[Sixth Embodiment]

In the description of the first to fifth embodiments, the feature extraction unit generates a 2D feature image using a single feature extraction process. In the sixth embodiment, the feature extraction unit generates a plurality of 2D feature images using a plurality of feature extraction processes.

When the feature extraction unit generates a 2D feature image using a single feature extraction process, if 2D feature images before and after tampering have no difference, it is difficult to detect a tampered position.

However, when a plurality of feature extraction processes are done, if 2D feature images generated by one of these feature extraction processes have a difference before and after tampering, a tampered position can be detected.

In this embodiment, a plurality of 2D feature images generated by a plurality of feature extraction processes are calculated by both the embedding apparatus and tampered position detection apparatus, and images obtained using identical extraction processes are compared. Hence, a tampered position of an image, which cannot be detected in the first to fifth embodiments, can be easily detected.

As a simple example, a first feature extraction unit may extract a 2D feature image based on low-frequency components (LL) of discrete wavelet transformation, and a second feature extraction unit may extract a 2D feature image based on high-frequency components (HH) of discrete wavelet transformation. The number of gray levels of each 2D feature image must be reduced to fall in image region B in correspondence with the information size of image region B. However, since both low- and high-frequency components are contained in the 2D feature images, it becomes harder to generate a tampered image which does not change in 15, both these components before and after tampering, and tampered position detection of an image can be facilitated.

Alternatively, a first feature extraction unit extracts a multi-valued reduced image as a 2D feature image, and a second feature extraction unit extracts the edge of an image as a 2D feature image. In this case as well, it is difficult to generate a tampered image which is free from any change in edge while maintaining the average value of the entire image, and tampered position detection of an image can be facilitated.

In this case, the watermark information contains these 2D feature-images, and information indicating processes used to generate these 2D feature images.

The tampered position detection apparatus similarly generates a plurality of 2D feature images for a tampered image, and compares corresponding ones of 2D feature images extracted from the watermark information, and those which are generated from the tampered image (images obtained by an identical extraction process), thus detecting a tampered position.

Note that the process according to this embodiment may be applied to the above embodiments.

[Seventh Embodiment]

This embodiment will examine a case wherein image data in which a digital watermark for tampered position detection is to be embedded is JPEG compression-encoded data. Since the JPEG compression-encoding scheme is well known to those who are skilled in the art, a detailed description thereof will be omitted.

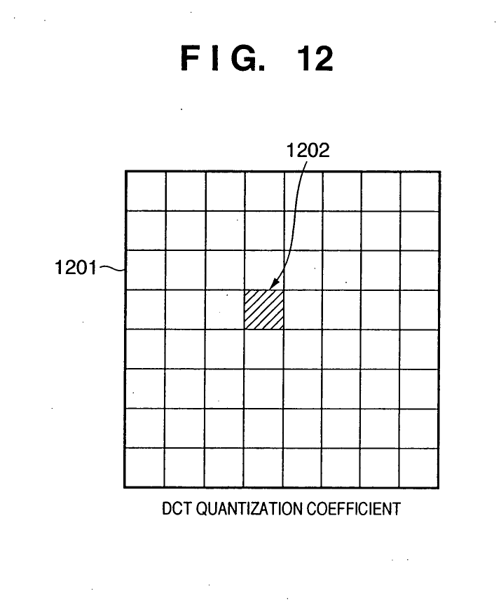

FIG. 12 shows a two-dimensional matrix of DCT quantization coefficients which are obtained by computing the discrete cosine transforms of a partial region (8×8 pixels) of an image and quantizing the transformation coefficients using a predetermined quantization table.

In the coefficient matrix shown in FIG. 12, a DC component (DC, the average value of 8×8 pixels) is set at the upper left position, and unique frequency components are set at the remaining positions.

When a digital watermark for tampered position detection described in the first to fourth embodiments is to be embedded in JPEG compression-encoded data, one or a plurality of frequency components which have little influence on image quality in each 8×8 block may be selected as image region B as an object in which a digital watermark is to be embedded, and the remaining components may be selected as image region A. For example, a frequency component 1202 may be selected as image region B, and other frequency components may be selected as image region A, as shown in FIG. 12.

Upon generating a 2D feature image, a binary image may be generated for only DC components in image region A. Upon generating a digest, all data in image region A may be used. In such case, even when a luminance or color has changed in a JPEG compression-encoded image, a tampered position can be specified.

[Eighth Embodiment]

This embodiment will examine a case wherein image data in which a digital watermark for tampered position detection is to be embedded is JPEG2000 compression-encoded data.

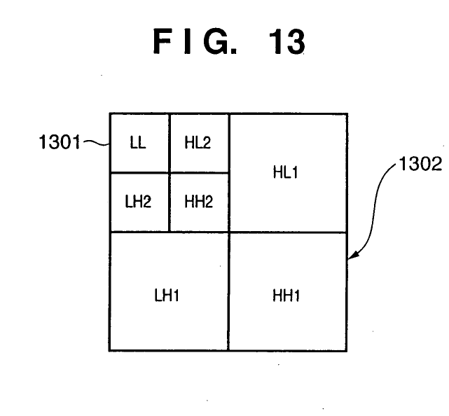

Since the JPEG2000 compression-encoding scheme is well known to those who are skilled in the art, a detailed description thereof will be omitted. In the JPEG2000 compression-encoding scheme, an input image is segmented into tiles each having a predetermined size, and the discrete wavelet transforms (DWT) of each tile are computed to segment each tile into subbands of a plurality of frequency bands. FIG. 13 shows the layout of DWT coefficients obtained by computing the discrete wavelet transforms of a tile of interest. LL at the upper left position is a subband indicating a low-frequency component which has a largest influence on an image, and HH at the lower right position is a subband indicating a high-frequency components which has little influence on an image.

An example for embedding a digital watermark for tampered position detection described in the first to sixth embodiments in JPEG2000 compression-encoded data will be explained below. In such case, the least significant bit plane (LL) may be selected as image region B, and bit planes except for the least significant bit plane (LL) may be selected as image region A. In this case, since LL can be considered as a 2D image consisting of a plurality of bit planes, the digital watermark embedding process for tampered position detection, and tampered position detection process can be implemented in substantially the same manner as in the first and second embodiments. Upon manipulating LL, the image quality readily deteriorates, but a function of specifying a tampered position even for compression that removes high-frequency subbands can be maintained.

As another embedding method, all subbands (HL1, HH1, LH1, HL2, HH2, LH2) except for LL may be selected as image region B, and LL itself or a 2D feature image obtained from LL may be embedded in image region B. As image region B, predetermined bit planes may be selected from (HL1, HH1, LH1, HL2, HH2, LH2) in place of all subbands except for LL. In such case, an information size to be stored in image region B is reduced, but deterioration of an image can be suppressed.

Also, image regions A and B may be selected for each tile as a minimum unit of discrete wavelet transformation, and the digital watermark embedding process for tampered position detection, and tampered position detection process may be executed. Alternatively, image regions A and B may be selected from a plurality of tiles on the entire image in place of each tile, and the digital watermark embedding process for tampered position detection, and tampered position detection process may be executed.

For example, only LL subbands are extracted from a plurality of tiles, a region except for the least significant bit plane is set as image region A, and the least significant bit plane is set as image region B. In this case, as has already been described in the first to third embodiments, a 2D feature image may generated from image region A to generate watermark information, and watermark information which is obtained by applying an encryption process, error-correction encoding process, and interleave process to the generated watermark information may be replaced by image region B.

[Ninth Embodiment]

This embodiment will examine a case wherein image data in which a digital watermark for tampered position detection is to be embedded is moving image data represented by MPEG, MotionJPEG, and MotionJPEG2000. MPEG is based on compression which is attained on the basis of discrete cosine transformation used in JPEG compression encoding, and the digital watermark embedding method for tampered position detection in a JPEG compression-encoded image described in the seventh embodiment can be applied by extending the method to the time domain and appropriately selecting DCT coefficients which have little influence on image quality.

MotionJPEG or MotionJPEG2000 basically has a format formed by superposing JPEG or JPEG2000 compression encoded images along the time axis, and the method described in the fifth or sixth embodiment can be easily applied by extending it to the time domain.

Also, audio data may be used as an object to be processed in the respective embodiments. In such case, each of the embodiments can be applied by replacing a 2D feature image by linear feature data.

[10th Embodiment]

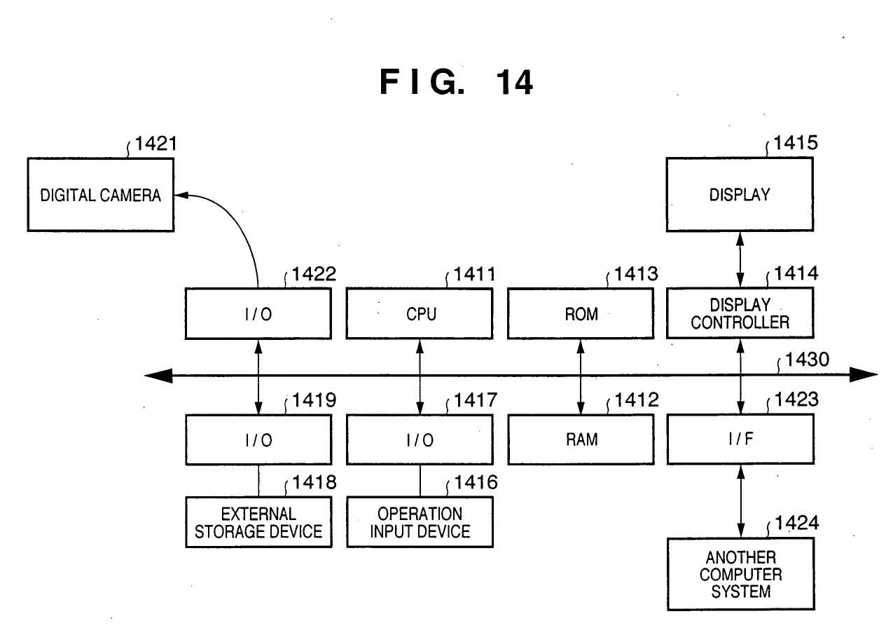

In this embodiment, each of the processes according to the first to ninth embodiments is implemented by a computer. FIG. 14 is a block diagram showing the basic arrangement of a computer which serves as the embedding apparatus and tampered position detection apparatus according to the first to ninth embodiments. For example, when this computer is to function as the embedding apparatus and tampered position detection apparatus according to the first to third embodiments, the functional arrangements shown in FIGS. 1, 4, 9, 10, and 17 are described by programs, and these programs are loaded onto this computer, thus making the computer function as the embedding apparatus and tampered position detection apparatus according to the first to third embodiments.

The embedding apparatus and tampered position detection apparatus may be combined into a single apparatus or may be independent apparatuses.

Referring to FIG. 14, reference numeral 1411 denotes a CPU which controls the overall computer and executes the processes described in the above embodiments using programs and data stored in a RAM 1412 and ROM 1413.

The RAM 1412 comprises an area for temporarily storing program and data loaded from an external storage device 1418, and those downloaded from another computer system 1424 via an I/F (interface) 1423, and also an area required for the CPU 1411 to execute various processes.

The ROM 1413 stores a boot program, setup data, and the like of the computer. Reference numeral 1414 denotes a display controller which executes a control process for displaying images, text, and the like on a display 1415. The display 1415 displays images, text, and the like. Note that a CRT, liquid crystal display, and the like may be used as the display.

Reference numeral 1416 denotes an operation input device which comprises devices such as a keyboard, mouse, and the like, which can input various instructions to the CPU 1411. When the private key, public key, and the like are to be manually input, they can be input via this operation input device 1416. Reference numeral 1417 denotes an I/O used to send various instructions and the like input via the operation input device 1416 to the CPU 1411.

Reference numeral 1418 denotes an external storage device which serves as a large-capacity information storage device such as a hard disk or the like, and stores an OS (operating system), programs that makes the CPU 1411 implement the processes according to the above embodiments, image data in which embedding information is to be embedded, and the like. Also, the external storage device may pre-store a private key. Information is written in/read out from the external storage device 1418 via an I/O 1419.

Reference numeral 1421 denotes a digital camera used to sense an image. The sensed image is output to the RAM 1412 via an I/O 1422 or is saved in the external storage device 1418. Note that a device for sensing an image is not limited to the digital camera, but may be, for example, a digital video camera that senses a moving image.

Reference numeral 1430 denotes a bus which interconnects the CPU 1411, ROM 1413, RAM 1412, I/O 1422, I/O 1419, display controller 1414, I/F 1423, and I/O 1417.

When an audio signal is to undergo the digital watermark embedding process for tampered position detection and tampered position detection process, an audio input device such as a microphone or the like is connected to the I/O 1422 in place of the digital camera 1421.

In this embodiment, the digital watermark embedding process for tampered position detection and tampered position detection process are executed by the computer. Alternatively, a dedicated hardware circuit may execute the digital watermark embedding process for tampered position detection immediately after the digital camera 1421 senses digital data, and the CPU 1411 may execute the tampered position detection process. Of course, the digital camera 1421 may execute the digital watermark embedding process for tampered position detection.

When a digital watermark for tampered position detection is to be embedded in audio data, the audio input device may execute the digital watermark embedding process for tampered position detection (although not shown).

According to the above embodiments, the tampered position and the presence/absence of tampering of image, moving image, and audio data can be detected without using any secret information in the image, moving image, and audio data.

Note that the above embodiments are merely examples upon practicing the present invention, and the technical scope of the present invention must not be limitedly interpreted by these embodiments. That is, the present invention can be practiced in various forms without departing from its technical scope or principal feature.

<Other Embodiments>

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

What is claimed is:

1. An image processing apparatus for generating information that allows to detect a position of tampering for an original image which is formed of first and second regions, comprising:
feature image generation means for generating a feature image of the original image using an image of the first region;
watermark information generation means for generating watermark information which contains the feature image and information associated with the original image;
error-correction encoding means for generating error-correction encoded watermark information by making error-correction encoding of the watermark information; and
output means for outputting, as an output image, an image formed by replacing image information of the second region in the original image by the error-correction encoded watermark information.

2. The apparatus according to claim 1, further comprising:
encryption means for encrypting the watermark information generated by said watermark information generation means, and
wherein said error-correction encoding means makes error-correction encoding of the watermark information encrypted by said encryption means.

3. The apparatus according to claim 2, further comprising:
reordering means for reordering a bit sequence which forms the error-correction encoded watermark information, and
wherein the bit sequence of the error-correction encoded watermark information is reordered by said reordering means.

4. The apparatus according to claim 1, further comprising:
Hash value calculation means for calculating a Hash value using the image of the first region, and
wherein said watermark information generation means further stores data of the Hash value in the watermark information.

5. The apparatus according to claim 1, wherein the information associated with the original image contains a bit sequence used to check if the watermark information is normally decoded.

6. The apparatus according to claim 5, wherein the bit sequence is a Hash value for a part of the watermark information that contains at least the feature image.

7. The apparatus according to claim 1, wherein the information associated with the original image contains information used to specify a process for generating the feature image.

8. The apparatus according to claim 1, wherein said feature image generation means generates a plurality of feature images of the original image by executing different feature extraction processes.

9. The apparatus according to claim 1, wherein the feature image is a partial image of the original image.

10. An image processing apparatus for detecting a position of tampering in a tampered image which is formed of first and second regions, comprising:
error-correction decoding means for making error-correction decoding of an image based on the second region to reclaim watermark information which contains a feature image that represents a feature of the tampered image before tampering, and information associated with an image before tampering of the tampered image;
feature image generation means for generating a feature image of the tampered image using an image of the first region; and
tampered position notifying means for notifying the position of tampering in the tampered image using the feature image which is contained in the watermark information and represents the feature of the tampered image before tampering, and the feature image of the tampered image.

11. An image processing apparatus for generating information that allows to detect a position of tampering for an original image which is formed of first and second regions, comprising:
encryption means for encrypting watermark information, which is generated in advance, to generate encrypted watermark information;
error-correction encoding means for making error-correction encoding of the encrypted watermark information to generate error-correction encoded encrypted watermark information; and
output means for outputting, as an output image, an image formed by replacing image information of the second region in the original image by the error-correction encoded encrypted watermark information.

12. An image processing apparatus for detecting a position of tampering in a tampered image which is formed of first and second regions, comprising:
error-correction decoding means for making error-correction decoding of an image based on the second region to generate an error-corrected image based on the second region, so as to reclaim encrypted watermark information;
decryption means for decrypting the encrypted watermark information to reclaim watermark information;
watermark information verification means for verifying consistency of the watermark information; and
tampered position detection means for, when the watermark information meets the consistency, detecting a tampered position by comparing the image based on the second region and the error-corrected image based on the second region.

13. An image processing method for generating information that allows to detect a position of tampering for an original image which is formed of first and second regions, comprising:
a feature image generation step of generating a feature image of the original image using an image of the first region;
a watermark information generation step of generating watermark information which contains the feature image and information associated with the original image;
an error-correction encoding step of generating error-correction encoded watermark information by making error-correction encoding of the watermark information; and
an output step of outputting, as an output image, an image formed by replacing image information of the second region in the original image by the error-correction encoded watermark information.

14. An image processing method for detecting a position of tampering in a tampered image which is formed of first and second regions, comprising:
an error-correction decoding step of making error-correction decoding of an image based on the second region to reclaim watermark information which contains a feature image that represents a feature of the tampered image before tampering, and information associated with an image before tampering of the tampered image;
a feature image generation step of generating a feature image of the tampered image using an image of the first region; and
a tampered position notifying step of notifying the position of tampering in the tampered image using the feature image which is contained in the watermark information and represents the feature of the tampered image before tampering, and the feature image of the tampered image.

15. An image processing method for generating information that allows to detect a position of tampering for an original image which is formed of first and second regions, comprising:
an encryption step of encrypting watermark information, which is generated in advance, to generate encrypted watermark information;
an error-correction encoding step of making error-correction encoding of the encrypted watermark information to generate error-correction encoded encrypted watermark information; and
an output step of outputting, as an output image, an image formed by replacing image information of the second region in the original image by the error-correction encoded encrypted watermark information.

16. An image processing method for detecting a position of tampering in a tampered image which is formed of first and second regions, comprising:
an error-correction decoding step of making error-correction decoding of an image based on the second region to generate an error-corrected image based on the second region, so as to reclaim encrypted watermark information;
a decryption step of decrypting the encrypted watermark information to reclaim watermark information;
a watermark information verification step of verifying consistency of the watermark information; and
a tampered position detection step of detecting, when the watermark information meets the consistency, a tampered position by comparing the image based on the second region and the error-corrected image based on the second region.

17. A program for making a computer function as an image processing apparatus of claim 1.

18. A program for making a computer implement an image processing method of claim 13.

19. A computer readable storage medium storing a program of claim 17.

20. A computer readable storage medium storing a program of claim 18.
